SEQUENCE LISTING (2 sequences)

SEQ ID NO: 1 - DNA, 9 bp, Artificial Sequence
  Synthetic construct
gcggtccca

SEQ ID NO: 2 - DNA, 9 bp, Artificial Sequence
  Synthetic construct
tgggaccgc

(19) United States
(12) Patent Application Publication
(10) Pub. No.: US 2012/0035860 A1
(43) Pub. Date: Feb. 9, 2012

(54) GC Wave Correction for Array-Based Comparative Genomic Hybridization

(76) Inventors: Viatcheslav R. Akmaev, Brookline, MA (US); Angela Leo, Worcester, MA (US); Thomas Scholl, Westborough, MA (US)

(21) Appl. No.: 13/097,845

(22) Filed: Apr. 29, 2011

Related U.S. Application Data
(60) Provisional application No. 61/329,264, filed on Apr. 29, 2010.
(60) Provisional application No. 61/362,491, filed on Jul. 8, 2010.

(51) Int. Cl. G06F 19/18

(52) U.S. Cl. 702/20

(57) ABSTRACT

The present invention provides, among other things, new methods for optimizing comparative genomic hybridization (CGH) data analysis. In particular, the methods of the invention provide increased sensitivity and specificity due to the implemented individual chromosome-based GC-wave correction. In certain embodiments, the log ratios of probes derived from each chromosome are corrected based on the chromosome's GC content slope, and certain selected chromosomes undergo chromosomal median adjustment. As a result, the log ratios of the probes on the array are normalized to be closer to zero (0) for diploid regions and thus, the GC waves are substantially reduced, resulting in a reduced false positive rate. Systems, computer readable media, and kits for use in the optimized CGH methods also are provided.

### PRIOR RELATED APPLICATIONS

This application claims priority to U.S. Provisional Application No. 61/329,264, filed Apr. 29, 2010, and U.S. Provisional Application No. 61/362,491, filed Jul. 8, 2010, both of which are hereby incorporated by reference in their entirety.

### BACKGROUND

Many diseases, such as various cancers, associated with chromosomal imbalance (e.g., Patau syndrome, Down's syndrome, etc.), and certain immunological and neurological diseases are caused by genomic aberrations, including deletion, inversion, duplication, multiplication, chromosomal translocation and other rearrangements, and point mutation. These aberrations either directly cause the diseases, or predispose the individuals with such aberrations to the diseases. Individuals carrying such aberrations may be suffering from the diseases, be at risk of developing the diseases, or may be carriers for the diseases. In addition, the presence of certain aberrations determines the outcome of certain disease conditions. Therefore, screening for the status of these aberrations may provide valuable information useful for diagnosis, such as in prenatal and carrier tests. This information also may eliminate a significant number of unnecessary surgeries or other treatments. Better diagnostic information also may lead to improved prognosis for patients and proper clinical management, resulting in improved quality of life for patients with serious diseases, such as cancer patients. Additionally, study of these aberrations may be useful in building disease-mutation correlations for drug discovery.

For years, G-banded karyotyping and locus-specific fluorescence in situ hybridization (FISH) have been used to detect pathogenic copy number variants. Although these technologies are reliable for detecting clinically relevant genomic imbalances, they also have significant limitations. Current G-banded karyotyping protocols are limited by a detection resolution of about 3-5 Mb for detecting deletions throughout the genome. FISH can only assess DNA copy number aberrations in specific targeted loci and also has resolution limitations of 100 kb-1 Mb, depending on many factors including genomic location.

Array-based comparative genomic hybridization (aCGH) is a powerful technique used to detect copy number changes and other genomic aberrations. In aCGH, a test sample is typically compared to a reference sample to determine the existence of genomic aberrations. Typically, nucleic acids from the test sample are differentially labeled from nucleic acids from the reference sample, and nucleic acids from both samples are typically hybridized to a microarray of probes. Signals are then detected from nucleic acids hybridized to the microarray. Deviations of the log ratio of the signals generated from the labels of the test and reference nucleic acids from an expected value (e.g., zero for diploid regions) are detected and may be used as an indication of copy number differences.

The currently available aCGH techniques still have noteworthy limitations. For example, certain genome-wide artefacts commonly known as “GC waves” (which may be due to the guanine/cytosine (GC) content of the probes used in cCGH) can cause the log ratio to deviate from its expected value resulting in false positives. GC-waves can add large scale variability to the probe signal ratios and interfere with data analysis algorithms as they can skew signal logarithmic ratio data away from expected values. The GC-wave artefact can increase the potential for false positive aberration calls in specific genomic regions, and can also obscure true aberration calls (See Marioni et al., (2007), Genome Biology, 8:R228).

A few computational methods for addressing GC-waves have been published. Marioni et al. concluded that the wave effect strongly correlates with the GC content of the probe and developed a correction method based on lowess regression to improve copy number variation (CNV) calling accuracy for small CNV regions. However, that method is not applicable in the presence of larger aberrations which are often seen clinically. Nannya et al. considered both the GC content of the DNA fragments hybridizing to the array as well as their size when developing a quadratic regression method for Affymetrix SNP arrays (Cancer Research 2005, 14:6071-6079). Alternatively, Van de Wiel et al. created a set of calibration profiles from a subset of previous aCGH results to reduce the GC-waves in data from tumour samples based on ridge regression (Bioinformatics 2009, 9:1099-1104). Each of these methods is effective in reducing GC-wave patterns in some capacity, but these approaches generally require some a priori understanding of expected aCGH results, and in all cases, can lead a loss of sensitivity. While these approaches may be appropriate for discovery purposes or in certain cases where many aberrations are present, such as cancer samples, these methods are generally not suited for a clinical aCGH setting, as an algorithmic correction needs to be universally applicable and maintain assay sensitivity and specificity, with no prior knowledge or expectation of results in a particular sample.

Therefore, what are needed in the art are improved methods and systems for detecting genomic copy number variations. The desired methods should be efficient, precise, and sensitive, particularly for overcoming the interference created by the GC waves.

### SUMMARY OF THE INVENTION

The present invention provides improved methods of CGH data analysis that significantly reduce false positives and, as a result, increase sensitivity in CGH-based diagnosis of diseases, disorders, or conditions associated with genomic aberrations. The present methods rely on the discovery that GC waves can be effectively corrected for by adjusting the log ratios of the probes on each chromosome based on the chromosome's GC content in combination with selected chromosomal median adjustment.

In some embodiments, the present invention provides methods of aCGH data analysis comprising the steps of determining log ratio values for a plurality of probes hybridized to a genome of a test sample and a genome of a reference sample, wherein the reference sample has a known ploidy, and wherein each individual probe has a known chromosome location and a predetermined GC content; determining a log ratio base line for each chromosome based on the GC content of the chromosome; and normalizing the log ratio value for each individual probe against the log ratio baseline of the corresponding chromosome from which the individual probe is derived. The log ratio values for the array of probes may be determined directly or indirectly (e.g., by obtaining the values from another source). In some embodiments, the step of determining the log ratio base line comprises a step of determining GC slope for each chromosome by comparing log ratios of probes derived from each chromosome to their respective percent GC. In some embodiments, the step of normalizing the log ratio value for each individual probe i comprises adjusting the log ratio value for each probe i by a correction factor defined by the following formula:

CorrectionFactorᵢ=LRBaseline−m·PercentGCᵢ−b (Eq. 1)

where m is the GC content slope of the probe's chromosome and b is the y-intercept.

In some embodiments, the present methods further comprise a step of determining median log ratios for individual chromosomes based on the normalized log ratio value for individual probes. In some embodiments, the present methods further comprise a step of assessing GC slope of the array, wherein if the GC slope of the array exceeds a pre-determined threshold, the test sample is excluded.

In some embodiments, the present methods further comprise a step of correcting a subset of chromosomes' log ratios by their respective chromosomal adjustment factors indicative of assay-based deviation from baseline (e.g., 0) for a normal diploid region. In some embodiments, the subset of chromosomes are selected from anchor chromosomes pre-determined to have skewed median log ratios that deviate from baseline (e.g., 0) in normal diploid regions. In some embodiments, the anchor chromosomes are pre-determined based on archived log ratio values obtained under the same assay conditions and have normalized median log ratios furthest from 0. In certain embodiments, the anchor chromosomes comprise at least one of chromosomes 3, 4, 5, 6, 13, 16, 17, 19, and 22. In other embodiments, other chromosomes may be used as anchor chromosomes. In some embodiments, each individual anchor chromosome j has an anchor value aⱼ defined by a slope of a trend line defined by plotting the archived median log ratios of chromosome j against the archived median log ratios of the anchor chromosome that was most skewed from baseline (e.g., 0). In some embodiments, the chromosomal adjustment factors are calculated from a subset of anchor chromosomes by excluding a plurality of outlier chromosomes whose median log ratios skew the furthest among the anchor chromosomes. In some embodiments, the percentage of anchor chromosomes that can be designated as outlier chromosomes is approximately 20%, 30%, 40%, or 50%. In one embodiment, approximately 40% of the anchor chromosomes are designated as outlier chromosomes.

In some embodiments, the outlier chromosomes are excluded by a least-squares fit analysis according to equation 2:

$$min {\sum }_{j = 1}^{x} {( {a}_{j} - e \cdot {m}_{j} )}^{2} \qquad ( Eq . 2 )$$

wherein aⱼ is the anchor value for individual anchor chromosome j and mⱼ is the normalized median log ratio value for individual anchor chromosome j. In some embodiments, the least-squares fit analysis comprises:

(i) calculating the summation of Eq. 2 for the set of x anchor chromosomes, each time omitting one chromosome in the set, such that each anchor chromosome in the set is omitted once during calculation, wherein a chromosome is identified as an outlier if its omission results in the smallest summation;

(ii) removing the outlier chromosome identified at step (i) from the set;

(iii) recursively searching the remaining x−1 anchor chromosomes for the next outlier using step (i);

(iv) repeating steps (i)-(iii) until 40% of the anchor chromosomes are excluded as outliers.

In some embodiments, the chromosomal adjustment factors for the set of anchor chromosomes to be corrected are determined using steps of finding an coefficient e* such that the difference between the anchor values a and e*m is minimized according to equation 1

$$min {\sum }_{j = 1}^{x} {( {a}_{j} - e \cdot {m}_{j} )}^{2} \qquad ( Eq . 2 )$$

wherein aⱼ is the anchor value for individual anchor chromosomeⱼ and mᵢ is the normalized median log ratio value for anchor chromosome j; and determining chromosome adjustment factor for anchor chromosome j as aⱼ/e*. In some embodiments, the set of chromosomes' log ratios are corrected by subtracting the corresponding chromosomal adjustment factor aⱼ/e* from the log ratios for individual probes derived from anchor chromosome j.

In some embodiments, the present methods further comprise a step of first comparing the summation of the subset of anchor chromosomes according to equation 2 as described above to a predetermined threshold, wherein if the summation exceeds the pre-determined threshold, the sample does not undergo chromosomal adjustment.

In some embodiments, the present methods further comprise a step of providing an output file comprising corrected log ratio values for individual probes for aberration detection. In some embodiments, aberration detection comprises a step of determining if the test sample contains abnormal copy numbers of a chromosome based on the corrected log ratio values. In some embodiments, the present methods further comprise a step of detecting a disease, disorder, or condition associated with the abnormal copy numbers of the chromosome, or a carrier thereof.

In some embodiments of the methods of the invention, the test sample is obtained from cells, tissue, whole blood, plasma, serum, urine, stool, saliva, cord blood, chorionic villus sample, chorionic villus sample culture, amniotic fluid, amniotic fluid culture, or transcervical lavage fluid. In some embodiments, the test sample is a prenatal sample.

In certain aspects, the present invention provides a system for aCGH data analysis, comprising: a) means to receive log ratio values for an array of probes hybridized to a genome of a test sample and a genome of a reference sample, wherein the reference sample has a known ploidy, wherein each individual probe has a known chromosome location and a pre-determined GC content; b) a storage device configured to store data comprising (i) the chromosome location and pre-determined GC content for each individual probe, (ii) GC content for each chromosome, and (iii) anchor values for pre-determined anchor chromosomes indicative of assay-dependent deviation; c) a determination module configured to determine a log ratio base line for each chromosome based on the GC content of the chromosome; d) a computing module adapted to (i) normalize the log ratio value for each individual probe against the log ratio baseline of the corresponding chromosome from which the individual probe is derived; (ii) calculate median log ratios for individual chromosomes based on the normalized log ratio value for individual probes, (iii) select a subset of anchor chromosomes by excluding outlier chromosomes whose median log ratios skew the furthest among the anchor chromosomes based on the anchor values and the normalized median log ratios for each anchor chromosome; (iv) calculate chromosomal adjustment factors indicative of assay-based deviation from baseline (e.g., 0) based on the subset of anchor chromosomes selected at step (iii) and normalize the anchor chromosomes' log ratio values against their respective chromosomal adjustment factors; (v) determine the quality of GC slope and/or the chromosomal adjustment factors to determine if the correction should be made; and e) a second storage device configured to store an output file comprising corrected log ratio values for individual probes for aberration detection. In some embodiments, the systems of the invention further comprise a means to carry out aberration detection.

In certain aspects, the present invention provides a computer readable medium having anchor values recorded thereon for anchor chromosomes pre-determined to have skewed median log ratios that deviate from baseline (e.g., 0) in normal diploid regions in a pre-determined aCGH assay, wherein the anchor value aⱼ for each individual anchor chromosome j is defined by a slope of a trend line defined by plotting archived median log ratios obtained using the pre-determined aCGH assay of chromosome j against archived median log ratios of the anchor chromosome that was most skewed from baseline (e.g., 0).

In certain other aspects, the present invention provides a kit for aCGH analysis, comprising: (a) an array of probes for aCGH analysis, wherein each individual probe has a known chromosome location and a pre-determined GC content; and (b) a computer-readable medium as described herein. In some embodiments, the kit further comprises one or more reagents for conducting the pre-determined aCGH assay.

Other features, objects, and advantages of the present invention are apparent in the detailed description, drawings, and claims that follow. It should be understood, however, that the detailed description, the drawings, and the claims, while indicating embodiments of the present invention, are given by way of illustration only, not limitation. Various changes and modifications within the scope of the invention will become apparent to those skilled in the art.

### BRIEF DESCRIPTION OF DRAWINGS

The present invention may be better understood by reference to the following non-limiting figures. The figures are for illustration purposes only, not for limitation.

FIG. 1 shows scatter plots of log-ratio (y axis) versus GC content (%, x axis) for specific probes. The linear regression (black line, equation) demonstrates the trend between log-ratio signal and GC content. FIG. 1A is scatter plot of log-ratio versus GC content for each probe on a custom 44K Agilent array. FIG. 1B is a scatter plot of the same data for probes mapping to chromosome 6, and FIG. 1C is a scatter plot of the same data for probes mapping to chromosome 9. These scatter plots illustrate the variability of the slope and intercept of the regression between individual chromosomes in the same sample.

FIG. 2 is a schematic diagram illustrating an exemplary log ratio baseline for an exemplary chromosome. For a particular chromosome, the GC slope m is determined by plotting the log ratio values of the probes derived from that particular chromosome against their respective GC contents (e.g., as a percentage). A trend line (solid line) is fitted using a robust regression. The slope of the trend line and y-intercept data can be determined and used to derive the log ratio baseline (dotted line) for the chromosome. The comparative genomic hybridization slope and anchored median (cghSAM) algorithm calculates the median GC percentage for all probes on each chromosome. In the first step of the algorithm, the log-ratio baseline for a particular chromosome is determined using its slope and intercept. Individual probe log-ratios are adjusted by their correction factor (difference between the solid and dotted lines).

FIGS. 3A, 3B, and 3C are schematic diagrams illustrating exemplary possible chromosome outcomes after slope correction. Most chromosomes have a median log ratio close to the baseline (expected log₂ ratio for equal copy number between sample and reference; FIG. 3A). Some chromosome medians may be skewed to the positive or negative (FIGS. 3B and 3C). Chromosomal adjustment is used to correct the bias.

FIG. 4 is a schematic diagram outlining steps for chromosomal adjustment. The chromosome adjustment step of cghSAM adjusts selected chromosomes based on their median log-ratio. Set A contains the chromosomes with biased log-ratio medians. Steps 1 and 2 of the workflow are repeated until 40% of the chromosomes are removed as outliers. Once the adjustment factor is determined, all chromosomes in set A are corrected.

FIG. 5 illustrates exemplary wave effects in four samples across a region of chromosome 19, before correction (FIG. 5A) and after correction (FIG. 5B). GC slope is listed to the right. Each data point is an individual probe ordered by genomic location. The values are the sample/reference log₂ signal ratio. Grey signifies a probe log-ratio greater than 0.5, or less than −0.5. Black indicates probes with log-ratio values between −0.5 and 0.5.

FIG. 6 depicts exemplary results for a 10 probe region covering the GSTT1 locus in 215 samples. Triangles represent called deletions; plus signs represent called amplifications; and squares represent no aberration call. The tri-modal distribution density is displayed under the plot.

FIG. 7 depicts ADM2 sensitivity for deletion calling modeled as a function of probe number. Probes located on the X chromosome were binned in sets of 5-50 probes in samples hybridized with a female sample and a male reference (one X chromosome in the reference to two X chromosomes in the sample) in order to emulate a heterozygous deletion (a copy number change from two copies in the reference to one copy of a sample) and understand variability in probe performance. The model is applicable because the absolute value of log₂(2/1) is equal to the absolute value of log₂(1/2). The mean deletion detection sensitivity with ADM-2 set to 10.4 (dashed line) (the post-correction calling threshold) and 12.9 (solid line) (the pre-correction threshold) is shown with the error bars denoting ±1 SD.

FIG. 8 shows scatter plots of log-ratio (y axis) versus GC content (%, x axis) for specific probes. The linear regression (black line, equation) demonstrates the trend between log-ratio signal and GC content. FIG. 8A is scatter plot of log-ratio versus GC content for each probe on a custom 180K Agilent array. FIG. 8B is a scatter plot of the same data for probes mapping to chromosome 19. These scatter plots illustrate the variability of the slope and intercept of the regression between individual chromosomes in the same sample.

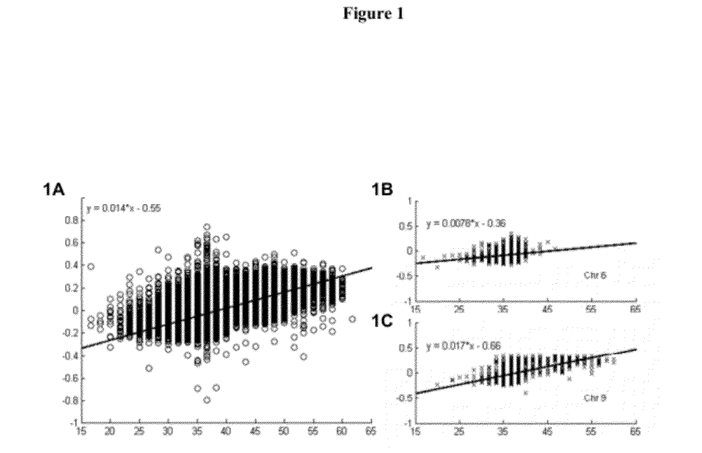

### DETAILED DESCRIPTION

The present invention provides, among other things, a new method of optimizing array-based comparative genomic hybridization (aCGH) data analysis based on individual chromosome-based GC-wave correction. In particular, the methods of the invention may involve two-part correction. First, the log ratios of the probes derived from each chromosome are corrected based on the chromosome's GC content slope. Then certain selected chromosomes undergo chromosomal median adjustment. As a result, the log ratios of the probes on the array are normalized to be closer to zero (0) for diploid regions and thus, the “waves” are substantially reduced resulting in reduced false positive rate. In addition, the invention utilizes GC content slope as a quality control metric providing a pathway for removing those samples that are more likely to have false positive calls. One embodiment of the invention can be implemented as an algorithm executable by a computer.

### Definitions

In order for the present invention to be more readily understood, certain terms are first defined below. Additional definitions for the following terms and other terms are set forth throughout the specification.

In this application, the use of “or” means “and/or” unless stated otherwise. As used in this application, the term “comprise” and variations of the term, such as “comprising” and “comprises,” are not intended to exclude other additives, components, integers, or steps. As used herein, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

As used herein, the term “amplification” refers to any methods known in the art for copying a target nucleic acid, thereby increasing the number of copies of a selected nucleic acid sequence. Amplification may be exponential or linear. A target nucleic acid may be either DNA or RNA. Typically, the sequences amplified in this manner form an “amplicon.” Amplification may be accomplished with various methods including, but not limited to, the polymerase chain reaction (“PCR”), transcription-based amplification, isothermal amplification, rolling circle amplification, etc. Amplification may be performed with relatively similar amount of each primer of a primer pair to generate a double stranded amplicon. However, asymmetric PCR may be used to amplify predominantly or exclusively a single stranded product as is well known in the art (e.g., Poddar et al. Molec. And Cell. Probes 14:25-32 (2000)). This can be achieved using each pair of primers by reducing the concentration of one primer significantly relative to the other primer of the pair (e.g., 100 fold difference). Amplification by asymmetric PCR is generally linear. A skilled artisan will understand that different amplification methods may be used together.

The term “aneuploidy” as used herein refers to an abnormal number of whole chromosomes or parts of chromosomes. Typically, aneuploidy causes a genetic imbalance which may be lethal at early stages of development, cause miscarriage in later pregnancy or result in a viable but abnormal pregnancy. The most frequent and clinically significant aneuploidies involve single chromosomes (strictly “aneusomy”) in which there are either three (“trisomy”) or only one (“monosomy”) instead of the normal pair of chromosomes.

As used herein, the terms “array”, “microarray,” “DNA array,” “nucleic acid array,” “chip,” and “biochip,” are used interchangeably and refer to a plurality of defined locations or spots with one or more biological molecules, e.g., nucleic acids, immobilized thereon. In some embodiments, the plurality of locations or spots is ordered in linear rows. In some embodiments, each biological molecule is a nucleic acid probe (e.g., an oligonucleotide).

As used herein, the terms “biological sample” and “biological specimen” are used interchangeably and encompass any sample obtained from a biological source. A biological sample can, by way of non-limiting example, include blood, amniotic fluid, sera, urine, feces, epidermal sample, skin sample, cheek swab, sperm, amniotic fluid, cultured cells, bone marrow sample and/or chorionic Convenient biological samples may be obtained by, for example, scraping cells from the surface of the buccal cavity. Cell cultures of any biological samples can also be used as biological samples, e.g., cultures of chorionic villus samples and/or aminoitic fluid cultures such as aminocyte cultures. A biological sample can also be, e.g., a sample obtained from any organ or tissue (including a biopsy or autopsy specimen), can comprise cells (whether primary cells or cultured cells), medium conditioned by any cell, tissue, organ, or tissue culture. In some embodiments, biological samples suitable for the invention are samples which have been processed to release or otherwise make available a nucleic acid for detection as described herein. Suitable biological samples may be obtained from a stage of life such as a fetus, young adult, adult (e.g., pregnant women), and the like. Fixed or frozen tissues also may be used.

As used herein, the terms “carrier” and “genetic carrier” are used interchangeably and refer to an individual that harbors a genetic mutation or allelic variant but displaying no symptoms of a disease associated with the genetic mutation or allelic variant. A carrier, however, is typically able to pass the genetic mutation or allelic variant onto their offspring, who may then express the mutated gene or allelic variant. Typically, this phenomenon is a result of the recessive nature of many genes. In certain embodiments, the mutation or allelic variant that the carrier harbors predisposes or is associated with a particular phenotype, for example, altered risk of developing a disease or condition, likelihood of progressing to a particular disease or condition stage, amenability to particular therapeutics, susceptibility to infection, immune function, etc. Without limitation, a carrier may have reduced or increased copy numbers of a gene or a portion of a gene. A carrier may also harbor mutations (e.g., point mutations, polymorphisms, deletions, insertions or translocations, etc.) within a gene.

As used herein, the phrase “copy number” when used in reference to a locus, refers to the number of copies of such a locus present per genome or genome equivalent. A “normal copy number” when used in reference to a locus, refers to the copy number of a normal or wild-type allele present in a normal individual. In certain embodiments, the copy number ranges from zero to two inclusive. In certain embodiments, the copy number ranges from zero to three, zero to four, zero to five, zero to six, zero to seven, or zero to more than seven copies, inclusive. In embodiments in which the copy number of a locus varies greatly across individuals in a population, an estimated median copy number could be taken as the “normal copy number” for calculation and/or comparison purposes.

As used herein, the term “coding sequence” refers to a sequence of a nucleic acid or its complement, or a part thereof, that can be transcribed and/or translated to produce the mRNA for and/or the polypeptide or a fragment thereof. Coding sequences include exons in a genomic DNA or immature primary RNA transcripts, which are joined together by the cell's biochemical machinery to provide a mature mRNA. The anti-sense strand is the complement of such a nucleic acid, and the coding sequence can be deduced therefrom. As used herein, the term “non-coding sequence” refers to a sequence of a nucleic acid or its complement, or a part thereof, that is not transcribed into amino acid in vivo, or where tRNA does not interact to place or attempt to place an amino acid. Non-coding sequences include both intron sequences in genomic DNA or immature primary RNA transcripts, and gene-associated sequences such as promoters, enhancers, silencers, etc.

As used herein, the terms “complement,” “complementary,” and “complementarity,” refer to the pairing of nucleotide sequences according to Watson/Crick pairing rules. For example, a sequence 5′-GCGGTCCCA-3′ has the complementary sequence of 5′-TGGGACCGC-3′. A complement sequence can also be a sequence of RNA complementary to the DNA sequence. Certain bases not commonly found in natural nucleic acids may be included in the complementary nucleic acids including, but not limited to, inosine, 7-deazaguanine, Locked Nucleic Acids (LNA), and Peptide Nucleic Acids (PNA). Complementarity need not be perfect; stable duplexes may contain mismatched base pairs, degenerative, or unmatched bases. Those skilled in the art of nucleic acid technology can determine duplex stability empirically considering a number of variables including, for example, the length of the oligonucleotide, base composition and sequence of the oligonucleotide, ionic strength and incidence of mismatched base pairs.

As, used herein, the terms “computer” and “processor” are used in their broadest general contexts and incorporate all such devices. Methods of the invention can be practiced using any computer/processor and in conjunction with any known software or methodology. For example, a computer/processor can be a conventional general-purpose digital computer, e.g., a personal “workstation” computer, including conventional elements such as microprocessor and data transfer bus. A computer/processor can further include any form of memory elements, such as dynamic random access memory, flash memory, or the like, or mass storage such as magnetic disc optical storage.

As used herein, the term “control” has its art-understood meaning of being a standard against which results are compared. Typically, controls are used to augment integrity in experiments by isolating variables in order to make a conclusion about such variables. In some embodiments, a control is a reaction or assay that is performed simultaneously with a test reaction or assay to provide a comparator. In one experiment, the “test” (i.e., the variable being tested) is applied. In the second experiment, the “control,” the variable being tested is not applied. In some embodiments, a control is a historical control (i.e., of a test or assay performed previously, or an amount or result that is previously known). In some embodiments, a control is or comprises a printed or otherwise saved record. A control may be a positive control or a negative control.

As used herein, the term “crude,” when used in connection with a biological sample, refers to a sample which is in a substantially unrefined state. For example, a crude sample can be cell lysates or biopsy tissue sample. A crude sample may exist in solution or as a dry preparation.

As used herein, the terms “fluorescent dye” and “fluorescent label” refer to any of a variety of entities comprising a fluorophore that, when stimulated by light of a particular wavelength, will emit light of a characteristic (and typically different) wavelength. Typically, a laser is use to excite a fluorophore and the emitted light is captured by a detector. In certain embodiments, the detector is a charge-coupled device (CCD) or a confocal microscope that record the intensity and/or wavelength of the emitted light. Numerous known fluorescent dyes of a wide variety of chemical structures and physical characteristics are suitable for use in the practice of the present invention. Suitable fluorescent dyes include, but are not limited to, fluorescein and fluorescein dyes (e.g., fluorescein isothiocyanine or FITC, naphthofluorescein, 4′,5′-dichloro-2′,7′-dimethoxyfluorescein, 6-carboxyfluorescein or FAM, etc.), carbocyanine, merocyanine, styryl dyes, oxonol dyes, phycoerythrin, erythrosin, eosin, rhodamine dyes (e.g., carboxytetramethyl-rhodamine or TAMRA, carboxyrhodamine 6G, carboxy-X-rhodamine (ROX), lissamine rhodamine B, rhodamine 6G, rhodamine Green, rhodamine Red, tetramethylrhodamine (TMR), etc.), coumarin and coumarin dyes (e.g., methoxycoumarin, dialkylaminocoumarin, hydroxycoumarin, aminomethylcoumarin (AMCA), etc.), Oregon Green Dyes (e.g., Oregon Green 488, Oregon Green 500, Oregon Green 514., etc.), Texas Red, Texas Red-X, SPECTRUM RED™, SPECTRUM GREEN, cyanine dyes (e.g., CY-3′, CY-S™, CY-3.5™, CY-5.5™, etc.), ALEXA FLUOR dyes (e.g., ALEXA FLUOR 350, ALEXA FLUOR™ 488, ALEXA FLUOR 532, ALEXA FLUOR 546, ALEXA FLUOR™ 568, ALEXA FLUOR 594, ALEXA FLUOR 633, ALEXA FLUOR 660, ALEXA FLUOR™ 680, etc.), BODIPY™ dyes (e.g., BODIPY™ FL, BODIPY™ R6G, BODIPY™ TMR, BODIPY™ TR, BODIPY™ 530/550, BODIPY™ 558/568, BODIPY™ 564/570, BODIPY™ 576/589, BODIPY™ 581/591, BODIPY™ 630/650, BODIPY™ 650/665, etc.), IRDyes (e.g., IRD40, IRD 700, IRD 800, etc.), and the like. For more examples of suitable fluorescent dyes and methods for coupling fluorescent dyes to other chemical entities such as proteins and peptides, see, for example, “The Handbook of Fluorescent Probes and Research Products”, 9th Ed., Molecular Probes, Inc., Eugene, Oreg.

Favorable properties of fluorescent labeling agents include high molar absorption coefficient, high fluorescence quantum yield, and photostability. In some embodiments, labeling fluorophores exhibit absorption and emission wavelengths in the visible (i.e., between 400 and 750 nm) rather than in the ultraviolet range of the spectrum (i.e., lower than 400 nm). In certain embodiments, fluorescent dyes are used as part of a system comprising more than one chemical entity such as in fluorescent resonance energy transfer (FRET). Resonance transfer results an overall enhancement of the emission intensity. For instance, see Ju et. al. (1995) Proc. Nat'l Acad. Sci. (USA) 92: 4347, the entire contents of which are herein incorporated by reference. To achieve resonance energy transfer, the first fluorescent molecule (the “donor” fluor) absorbs light and transfers it through the resonance of excited electrons to the second fluorescent molecule (the “acceptor” fluor). In one approach, both the donor and acceptor dyes can be linked together and attached to the oligo primer. Methods to link donor and acceptor dyes to a nucleic acid have been described previously, for example, in U.S. Pat. No. 5,945,526 to Lee et al., the entire contents of which are herein incorporated by reference. Donor/acceptor pairs of dyes that can be used include, for example, fluorescein/tetramethylrohdamine, IAEDANS/fluoroescein, EDANS/DABCYL, fluorescein/fluorescein, BODIPY™ FL/BODIPY FL™, and Fluorescein/QSY 7 dye. See, e.g., U.S. Pat. No. 5,945,526 to Lee et al. Many of these dyes also are commercially available, for instance, from Molecular Probes Inc. (Eugene, Oreg.). Suitable donor fluorophores include 6-carboxyfluorescein (FAM), tetrachloro-6-carboxyfluorescein (TET), 2′-chloro-7′-phenyl-1,4-dichloro-6-carboxyfluorescein (VIC), and the like.

As used herein, the term “hybridize” or “hybridization” refers to a process where two complementary nucleic acid strands anneal to each other under appropriately stringent conditions. Oligonucleotides or probes suitable for hybridizations typically contain 10-100 nucleotides in length (e.g., 18-50, 12-70, 10-30, 10-24, or 18-36 nucleotides in length). Nucleic acid hybridization techniques are well known in the art. See, e.g., Sambrook, et al., 1989, Molecular Cloning: A Laboratory Manual, Second Edition, Cold Spring Harbor Press, Plainview, N.Y. Those skilled in the art understand how to estimate and adjust the stringency of hybridization conditions such that sequences having at least a desired level of complementary will stably hybridize, while those having lower complementary will not. For examples of hybridization conditions and parameters, see, e.g., Sambrook, et al.; Ausubel, F. M. et al. 1994, Current Protocols in Molecular Biology. John Wiley & Sons, Secaucus, N.J.

As used herein, the term “gene” refers to a discrete nucleic acid sequence responsible for a discrete cellular (e.g., intracellular or extracellular) product and/or function. More specifically, the term “gene” may refer to a nucleic acid that includes a portion encoding a protein and optionally encompasses regulatory sequences, such as promoters, enhancers, terminators, and the like, which are involved in the regulation of expression of the protein encoded by the gene of interest. As used herein, the term “gene” can also include nucleic acids that do not encode proteins but rather provide templates for transcription of functional RNA molecules such as tRNAs, rRNAs, etc. Alternatively, a gene may define a genomic location for a particular event/function, such as a protein and/or nucleic acid binding site.

As used herein, the terms “genomic DNA” and “genomic nucleic acid” are used to refer to DNA (deoxyribonucleic acid) that represent at least part of the DNA from the genome of an organism. The terms “genomic DNA” and “genomic nucleic acid” encompass DNA that is isolated from one or more cells, as well as DNA that is amplified or cloned from genomic DNA, and/or is a synthetic version of genomic DNA. In some embodiments, genomic DNA is isolated from a nucleus of one or more cells. Genomic DNA can be from any source, including, but not limited to, tissues or cells taken directly from an individual, cultured cells, etc. Typically, the term “genomic DNA” is used to distinguish between DNA as it is present as at least part of a genome of an organism (e.g., as present in its chromosomal context) and other forms of DNA, such as copy DNA that is reverse-transcribed from mRNA (and typically lacking in certain gene elements such as introns). The term “genomic DNA” is also used to distinguish between DNA that is part of a cell or organism's genome and DNA from other elements that are not part of the genome, e.g., plasmid DNA. A sample of genomic DNA need not contain an entire genomic equivalent; genomic DNA samples may contain DNA from only a part of the genome of an organism.

As used herein, the terms “labeled” and “labeled with a detectable agent or moiety” are used interchangeably to specify that an entity (e.g., a nucleic acid probe, antibody, etc.) can be visualized, for example following binding to another entity (e.g., a nucleic acid, polypeptide, etc.). The detectable agent or moiety may be selected such that it generates a signal which can be measured and whose intensity is related to (e.g., proportional to) the amount of bound entity. A wide variety of systems for labeling and/or detecting proteins and peptides are known in the art. Labeled proteins and peptides can be prepared by incorporation of, or conjugation to, a label that is detectable by spectroscopic, photochemical, biochemical, immunochemical, electrical, optical, chemical or other means. A label or labeling moiety may be directly detectable (i.e., it does not require any further reaction or manipulation to be detectable, e.g., a fluorophore is directly detectable) or it may be indirectly detectable (i.e., it is made detectable through reaction or binding with another entity that is detectable, e.g., a hapten is detectable by immunostaining after reaction with an appropriate antibody comprising a reporter such as a fluorophore). Suitable detectable agents include, but are not limited to, radionucleotides, fluorophores, chemiluminescent agents, microparticles, enzymes, colorimetric labels, magnetic labels, haptens, molecular beacons, aptamer beacons, and the like.

The term “locus” is used herein to refer to the specific location of a particular DNA sequence on a chromosome. As used herein, a particular DNA sequence can be of any length (e.g., one, two, three, ten, fifty, or more nucleotides). In some embodiments, the locus is or comprises a gene or a portion of a gene. In some embodiments, the locus is or comprises an exon or a portion of an exon of a gene. In some embodiments, the locus is or comprises an intron or a portion of an intron of a gene. In some embodiments, the locus is or comprises a regulatory element or a portion of a regulatory element of a gene. In some embodiments, the locus is associated with a disease, disorder, and/or condition. For example, mutations at the locus (including deletions, insertions, splicing mutations, point mutations, etc.) may be correlated with a disease, disorder, and/or condition.

As used herein, the term “normal,” when used to modify the terms “copy number,” “locus,” “gene,” or “allele,” refers to the copy number or locus, gene, or allele that is present in the highest percentage in a population, e.g., the wild-type number or allele. When used to modify the term “individual” or “subject,” normal refers to an individual or group of individuals who carry the copy number or the locus, gene, or allele that is present in the highest percentage in a population, e.g., a wild-type individual or subject. Typically, a normal “individual” or “subject” does not have a particular disease or condition and is also not a carrier of the disease or condition. The term “normal” is also used herein to qualify a biological specimen or sample isolated from a normal or wild-type individual or subject, for example, a “normal biological sample.”

As used herein, the term “probe,” when used in reference to a probe for a nucleic acid, refers to a nucleic acid molecule having specific nucleotide sequences (e.g., RNA or DNA) that can bind or hybridize to nucleic acids of interest. Typically, probes specifically bind (or specifically hybridize) to nucleic acid of complementary or substantially complementary sequence through one or more types of chemical bonds, usually through hydrogen bond formation. In some embodiments, probes can bind to nucleic acids of DNA amplicons in a real-time PCR reaction.

As used herein, the term “reference sample” refers to a standard or control sample to which a test sample is compared. Typically, a reference sample used in the practice of the present invention is obtained from one or more cells, tissues, or organisms, with a known ploidy for a particular gene, locus, and/or chromosome being tested. A reference sample typically contains nucleic acids that are subject to the same manipulations (e.g., processing, preparation, and/or experimental manipulations) as the test sample. In some embodiments, one or more reference samples is/are run in parallel experiments with one or more test samples. In some embodiments, data obtained from a reference sample is used in subsequent experiments, e.g., archived reference data can be used for comparison purposes. In this case, a reference data set is typically only used at the stage of data analysis.

The term “signal” as used herein refers to a detectable and/or measurable entity. In certain embodiments, the signal is detectable by the human eye, e.g., visible. For example, the signal could be or could relate to intensity and/or wavelength of color in the visible spectrum. Non-limiting examples of such signals include colored precipitates and colored soluble products resulting from a chemical reaction such as an enzymatic reaction. In certain embodiments, the signal is detectable using an apparatus. In some embodiments, the signal is generated from a fluorophore that emits fluorescent light when excited, where the light is detectable with a fluorescence detector. In some embodiments, the signal is or relates to light (e.g., visible light and/or ultraviolet light) that is detectable by a spectrophotometer. For example, light generated by a chemiluminescent reaction could be used as a signal. In some embodiments, the signal is or relates to radiation, e.g., radiation emitted by radioisotopes, infrared radiation, etc. In certain embodiments, the signal is a direct or indirect indicator of a property of a physical entity. For example, a signal could be used as an indicator of amount and/or concentration of a nucleic acid in a biological sample and/or in a reaction vessel.

As used herein, the term “specific,” when used in connection with an oligonucleotide primer, refers to an oligonucleotide or primer that, under appropriate hybridization or washing conditions, is capable of hybridizing to the target of interest and not substantially hybridizing to nucleic acids which are not of interest. Higher levels of sequence identity are preferred and include at least 60%, 65%, 70%, 75%, 80%, 85%, 90%, 95%, 98%, 99%, or 100% sequence identity. In some embodiments, a specific oligonucleotide or primer contains at least 4, 6, 8, 10, 12, 14, 16, 18, 20, 22, 24, 26, 28, 30, 35, 40, 45, 50, 55, 60, 65, 70, or more bases of sequence identity with a portion of the nucleic acid to be hybridized or amplified when the oligonucleotide and the nucleic acid are aligned.

The term “subject” as used herein refers to a human or any non-human animal (e.g., mouse, rat, rabbit, dog, cat, cattle, swine, sheep, horse, or primate). A human includes pre and post natal forms. In many embodiments, a subject is a human being. A subject can be a patient, which refers to a human presenting to a medical provider for diagnosis or treatment of a disease. The term “subject” is used herein interchangeably with “individual” or “patient.” A subject can be afflicted with or is susceptible to a disease or disorder but may or may not display symptoms of the disease or disorder.

As used herein, the term “substantially” refers to the qualitative condition of exhibiting total or near-total extent or degree of a characteristic or property of interest. One of ordinary skill in the biological arts will understand that biological and chemical phenomena rarely, if ever, go to completion and/or proceed to completeness or achieve or avoid an absolute result. The term “substantially” is therefore used herein to capture the potential lack of completeness inherent in many biological and chemical phenomena.

As used herein, the term “substantially complementary” refers to two sequences that can hybridize under stringent hybridization conditions. The skilled artisan will understand that substantially complementary sequences need not hybridize along their entire length. In some embodiments, “stringent hybridization conditions” refer to hybridization conditions at least as stringent as the following: hybridization in 50% formamide, 5×SSC, 50 mM NaH2PO4, pH 6.8, 0.5% SDS, 0.1 mg/mL sonicated salmon sperm DNA, and 5×Denhart's solution at 42° C. overnight; washing with 2×SSC, 0.1% SDS at 45° C.; and washing with 0.2×SSC, 0.1% SDS at 45° C. In some embodiments, stringent hybridization conditions should not allow for hybridization of two nucleic acids which differ over a stretch of 20 contiguous nucleotides by more than two bases.

An individual who is “suffering from” a disease, disorder, and/or condition has been diagnosed with or displays one or more symptoms of the disease, disorder, and/or condition.

An individual who is “susceptible to” a disease, disorder, and/or condition has not been diagnosed with the disease, disorder, and/or condition. In some embodiments, an individual who is susceptible to a disease, disorder, and/or condition may not exhibit symptoms of the disease, disorder, and/or condition. In some embodiments, an individual who is susceptible to a disease, disorder, and/or condition will develop the disease, disorder, and/or condition. In some embodiments, an individual who is susceptible to a disease, disorder, and/or condition will not develop the disease, disorder, and/or condition.

As used herein, the term “wild-type” refers to the typical or the most common form existing in nature.

Various aspects of the invention are described in detail in the following sections. The use of sections is not meant to limit the invention. Each section can apply to any aspect of the invention.

### Array-Based Comparative Genomic Hybridization

The methods described herein can be used to analyze data generated from any comparative genomic hybridization (CGH) assay. In one embodiment, the method is performed using an array to generate array-based CGH (aCGH) data. In other embodiments, the method is performed using data that was already generated.

Generally, in aCGH, genomic DNA from a sample of interest (i.e., test sample) is hybridized to immobilized nucleic acid probes, each probe targeting a known segment of the genome, arranged as an array on a biochip or a microarray platform. Typically, a test sample is compared to a reference sample with known ploidy (e.g., known to be free of chromosomal aberrations) to determine the existence of copy number changes or other aberrations. In some embodiments, the test sample and reference sample are run in parallel. In this case, nucleic acids from the test sample are differentially labeled from nucleic acids from the reference sample, and nucleic acids from both samples are typically co-hybridized to an array of probes, which collectively cover the genome of interest. The resulting co-hybridization produces a fluorescently labeled array, the coloration of which reflects the competitive hybridization of sequences in the test and reference genomic DNAs to the homologous sequences within the arrayed probes. Signals are then detected from the array and compared. Theoretically, the copy number ratio of homologous sequences in the test and reference genomic DNA samples should be directly proportional to the ratio of their respective fluorescent signal intensities at discrete probe locations within the array. Deviations of the log ratio of the signals generated from the labels of the test and reference nucleic acids from an expected value (e.g., zero for diploid regions) are detected and may be used as an indication of copy number differences. In some embodiments, data obtained from a reference sample is used in subsequent experiments, e.g., archived reference data can be used for comparison purposes. In this case, only a test sample is hybridized to an array of probes and a reference data set is available at the stage of data analysis.

The versatility of the approach allows the detection of both constitutional variations in DNA copy number in clinical cytogenetic samples such as amniotic samples, chorionic villus samples (CVS), blood samples, and tissue biopsies, as well as somatically acquired changes in tumorigenically altered cells, for example, from bone marrow, blood or solid tumor samples.

The principle of the aCGH approach is further described in PCT Publication No. WO 93/18186 A1, which is incorporated by reference herein. PCT Publication No. WO 03/020898 A2 describes in detail exemplary CGH methods, the arrays suitable for carrying out the method, which are incorporated herein by reference.

Probes and Arrays

aCGH can provide DNA sequence copy number information across the entire genome in a single, timely, cost effective and sensitive procedure, the resolution of which is primarily dependent upon the number, size, and map positions of the probes used in the array. Typically, probes for aCGH are derived from known genomic segments by, e.g., recombinant DNA technology or chemical synthesis. In some embodiments, bacterial artificial chromosomes (BACs) are used in the production of the array. Known genomic segments are cloned in BACs, which are vectors that can accommodate on average about 150 kilobases (kb) of cloned genomic DNA per BAC. However, other sources of genomic DNA's in other vector sources may be used, including P1 phage-based artificial chromosome (PAC), cosmid, yeast artificial chromosome (YAC), mammalian artificial chromosome (MAC), human artificial chromosome, or even a plasmid or viral-based vector, which may contain genomic DNA inserts of relatively small size (such as 500 bp to 2 kb). In some embodiments, probes can be synthesized based on genomic sequence information. Thus, probes suitable for the present invention may be in various lengths, e.g., from 20 nucleotides to more than a few thousand nucleotides. In some embodiments, suitable probes may contain 50-150 nucleotides (e.g., 50, 60, 70, 80, 90, 100, 110, 120, 130, 140, or 150 nucleotides).

Probes with different sizes can be used in experiments of different resolution. Large genomic DNA fragments may be used for initial screening of large, unknown aberrations in certain diseases, while high resolution small clones may be used for assaying a pre-determined region harboring a specific mutation. The small fragment size arrays also may be used for high resolution whole genome screen, but such use may require significantly higher numbers of probes and/or arrays. A typical microarray may contain more than 40,000 probes (e.g., 42,000, 44,000, 46,000, 48,000, 50,000, 55,000, 60,000 or more). Typically, a plurality of arrays are used (e.g., 2, 3, 4, 5, 6, 7, 8, 9, 10, or more arrays).

The present invention can be practiced with any known “array,” also referred to as a “microarray,” “DNA array,” “nucleic acid array,” “biochip,” or variation thereof. Arrays are generically a plurality of “locations” or “spots,” each location or spot containing a defined amount of one or more probes, immobilized thereon. Typically, the immobilized probes are contacted with a sample for specific binding, e.g., hybridization, between molecules in the sample and the array. Probes of the arrays may be arranged on the substrate surface at different sizes and different densities. A suitable array can comprise nucleic acid probes immobilized on any substrate, e.g., a solid surface (e.g., nitrocellulose, glass, quartz, fused silica, plastics and the like). See, e.g., U.S. Pat. No. 6,063,338 describing multi-well platforms comprising cycloolefin polymers if fluorescence is to be measured. Arrays used in certain embodiments of the methods of the invention can comprise a housing comprising components for controlling humidity and temperature during the hybridization and wash reactions. Immobilized nucleic acid probes can contain sequences from specific messages (e.g., as cDNA libraries) or genes (e.g., genomic libraries), including, e.g., substantially all or a subsection of a chromosome or substantially all of a genome, such as a human genome. An array can also include control probes containing reference sequences, such as positive and negative controls, and the like.

According to the present invention, the chromosome location and GC content of each probe for each hybridization reaction and/or at each defined array location or spot is pre-determined and recorded to generate two configuration files that are specific to the array design, the chromosomal location file and the GC file. The chromosomal location file contains the chromosome number and the genomic coordinates corresponding to each probe sequence associated with each defined location or spot on the array. The GC file contains the percent GC of each probe associated with each defined location or spot on the array. These files are specific to the design of the array and are generated each time a new design is implemented. To achieve this, probes can be synthesized in situ on the surface of the array support (e.g., glass, microchips, and the like) using, e.g., inkjet technologies. Such arrays can be custom designed and synthesized by manufacturers such as Agilent Technologies, Inc. and Affymetrix.

Preparation of Genomic Nucleic Acids

The present invention provides methods for detecting a genetic aberration in any sample comprising a nucleic acid, such as a cell population or tissue or fluid sample, using an aCGHbased assay. The nucleic acid can be derived from (e.g., isolated from, amplified from, cloned from) genomic DNA of any source. In some embodiments, the cell, tissue sample, or fluid sample from which the nucleic acid sample is prepared is taken from a patient suspected of having a disease, disorder, or condition associated with genetic aberrations such as abnormal copy number of genes or chromosomes, or a carrier thereof. The invention can also be used for facilitating the diagnosis or prognosis of the pathology or condition associated with genetic defects, e.g., a cancer or tumor comprising cells with genomic nucleic acid base substitutions, amplifications, deletions and/or translocations. The cell, tissue sample, or fluid sample can be from, e.g., amniotic fluid samples, chorionic villus samples (CVS), serum, blood, cord blood, urine, cerebrospinal fluid (CSF), bone marrow aspirations, fecal samples, saliva, tears, tissue and surgical biopsies, needle or punch biopsies, and the like.

Methods of isolating cells, tissue samples, or fluid samples are well known to those of skill in the art and include, but are not limited to, aspirations, tissue sections, drawing of blood or other fluids, surgical or needle biopsies, and the like. A “clinical sample” derived from a patient includes frozen sections or paraffin sections taken for histological purposes. The sample can also be derived from supernatants of cell cultures, lysates of cells, and cells from tissue culture in which it may be desirable to detect levels of genetic aberration, including chromosomal abnormalities and copy numbers.

In some embodiments, the nucleic acids may be amplified first using standard techniques such as PCR and whole genome amplification.

Fragmentation and Digestion of Nucleic Acid

In some embodiments, the genomic nucleic acid can be fragmented or digested to generate a desirable length. Generally, it is thought that use of genomic DNA with small size fragments typically improves the resolution of the molecular profile analysis, e.g., in array-based CGH. For example, use of small fragments allows for significant suppression of repetitive sequences and other unwanted, “background” cross-hybridization on the immobilized nucleic acid, which increases the reliability of the detection of copy number differences (e.g., amplifications or deletions) or detection of unique sequences.

Various methods may be used to fragment or digest the genomic DNA into small fragments. For example, restriction endonucleases can be used to digest genomic DNA using standard protocols with or without other fragmentation procedures (see, e.g., Sambrook, Ausubel,). The resultant fragment lengths can be modified by, e.g., treatment with DNase. Adjusting the ratio of DNase to DNA polymerase in a nick translation reaction changes the length of the digestion product. Standard nick translation kits typically generate 300 to 600 base pair fragments. Random enzymatic digestion of the DNA can also be carried out, using, e.g., a DNA endonucleases, e.g., DNase (see, e.g., Herrera (1994) J. Mol. Biol. 236:405-411; Suck (1994) J. Mol. Recognit. 7:65-70).

Other procedures can also be used to fragment genomic DNA, e.g., mechanical shearing, sonication (see, e.g., Deininger (1983) Anal. Biochem. 129:216-223), and the like (see, e.g., Sambrook, Ausubel, Tijssen). For example, one mechanical technique is based on point-sink hydrodynamics that result in small fragments when a DNA sample is forced through a small hole by a syringe pump (see, e.g., Thorstenson (1998) Genome Res. 8:848-855). See also, Oefner (1996) Nucleic Acids Res. 24:3879-3886; Ordahl (1976) Nucleic Acids Res. 3:2985-2999.

If desired, fragment size can be evaluated by a variety of techniques, including, e.g., sizing electrophoresis, as by Siles (1997) J. Chromatogr. A. 771:319-329, that analyzed DNA fragmentation using a dynamic size-sieving polymer solution in a capillary electrophoresis. Fragment sizes can also be determined by, e.g., matrix-assisted laser desorption/ionization time-of-flight mass spectrometry (see, e.g., Chiu (2000) Nucleic Acids Res. 28:E31).

Incorporating Labels and Scanning Detection

The methods of the invention use nucleic acids associated with a detectable label, e.g., have incorporated or have been conjugated to a detectable moiety. Any detectable moiety can be used. The association with the detectable moiety can be covalent or non-covalent. Typically test sample nucleic acids and reference nucleic acids are differentially detectable, e.g., they have different labels and emit difference signals.

In some embodiments, useful labels may include, but are not limited to, fluorescent dyes (e.g., Cy5™, Cy3™, FITC, rhodamine, lanthanide phosphors, Texas red), electron-dense reagents (e.g. gold), enzymes, e.g., as commonly used in an ELISA (e.g., horseradish peroxidase, beta-galactosidase, luciferase, alkaline phosphatase), colorimetric labels (e.g. colloidal gold), magnetic labels (e.g. Dynabeads™), biotin, dioxigenin, or haptens and proteins for which antisera or monoclonal antibodies are available. In certain embodiments, the label may be directly incorporated into the nucleic acid to be detected, or it can be attached to a probe or antibody that hybridizes or binds to the target. The label can be attached by spacer arms of various lengths to reduce potential steric hindrance or impact on other useful or desired properties (See, e.g., Mansfield (1995) Mol Cell Probes 9:145-156).

In array-based CGH, fluors can be paired together; for example, one fluor labeling the control or reference (e.g., the nucleic acid of known, or normal, ploidy) and another fluor labeling the test nucleic acid (e.g., from a patient sample). Exemplary pairs are: rhodamine and fluorescein (see, e.g., DeRisi (1996) Nature Genetics 14:458-460); lissamine-conjugated nucleic acid analogs and fluorescein-conjugated nucleotide analogs (see, e.g., Shalon (1996) supra); Spectrum Red™ and Spectrum Green™ (Vysis, Downers Grove, Ill.); and Cy3™ and Cy5™. Cy3™ and Cy5™ can be used together; both are fluorescent cyanine dyes produced by Amersham Life Sciences (Arlington Heights, Ill.). Cyanine and related dyes, such as merocyanine, styryl and oxonol dyes, are particularly strongly light-absorbing and highly luminescent (see, e.g., U.S. Pat. Nos. 4,337,063; 4,404,289; and 6,048,982).

Other fluorescent nucleotide analogs can be used (see, e.g., Jameson (1997) Methods Enzymol. 278:363-390; Zhu (1994) Nucleic Acids Res. 22:3418-3422). U.S. Pat. Nos. 5,652,099 and 6,268,132 also describe nucleoside analogs for incorporation into nucleic acids, e.g., DNA and/or RNA, or oligonucleotides, via either enzymatic or chemical synthesis to produce fluorescent oligonucleotides. U.S. Pat. No. 5,135,717 describes phthalocyanine and tetrabenztriazaporphyrin reagents for use as fluorescent labels.

Detectable moieties can be incorporated into genomic nucleic acid by covalent or non-covalent means, e.g., by transcription, such as by random-primer labeling using Klenow polymerase, “nick translation,” amplification, or equivalent. For example, in one aspect, a nucleoside base is conjugated to a detectable moiety, such as a fluorescent dye, e.g., Cy3™ or Cy5™, and then incorporated into a sample genomic nucleic acid. Samples of genomic DNA can be incorporated with Cy3™—or Cy5™-dCTP conjugates mixed with unlabeled dCTP. Cy5™ is typically excited by the 633 nm line of HeNe laser, and emission is collected at 680 nm (See also, e.g., Bartosiewicz (2000) Archives of Biochem. Biophysics 376:66-73; Schena (1996) Proc. Natl. Acad. Sci. USA 93:10614-10619; Pinkel (1998) Nature Genetics 20:207-211; Pollack (1999) Nature Genetics 23:41-46).

In some embodiments, nucleic acids can be attached to another nucleic acid, e.g., a nucleic acid in the form of a stem-loop structure as a “molecular beacon” or an “aptamer beacon.” Molecular beacons as detectable moieties are well known in the art. For example, Sokol synthesized “molecular beacon” reporter oligodeoxynucleotides with matched fluorescent donor and acceptor chromophores on their 5′ and 3′ ends ((1998) Proc. Natl. Acad. Sci. USA 95:11538-11543). In the absence of a complementary nucleic acid strand, the molecular beacon remains in a stem-loop conformation where fluorescence resonance energy transfer prevents signal emission. On hybridization with a complementary sequence, the stem-loop structure opens increasing the physical distance between the donor and acceptor moieties thereby reducing fluorescence resonance energy transfer and allowing a detectable signal to be emitted when the beacon is excited by light of the appropriate wavelength (see also Antony (2001) Biochemistry 40:9387-9395, describing a molecular beacon comprised of a G-rich 18-mer triplex forming oligodeoxyribonucleotide. See also U.S. Pat. Nos. 6,277,581 and 6,235,504 for other examples of molecular beacons.

Various other nucleic acid labeling methods are well known in the art and can be used to practice the present invention.

Hybridization

In practicing certain embodiments of the methods of the invention, genomic nucleic acids are hybridized to immobilized probes. Typically, the hybridization and/or wash conditions are carried out under moderate to stringent conditions. An extensive guide to the hybridization of nucleic acids is found in, e.g., Sambrook, Ausubel, and Tijssen. Generally, highly stringent hybridization and wash conditions are selected to be about 5° C. lower than the thermal melting point (Tₘ) for the specific sequence at a defined ionic strength and pH. The Tₘ, is the temperature (under defined ionic strength and pH) at which 50% of the target sequence hybridizes to a perfectly matched probe. Very stringent conditions are selected to be equal to the Tₘ, for a particular probe.

In some embodiments, if the fluorescent dyes Cy3™ and Cy5™ are used to differentially label nucleic acid fragments from test and reference samples, reagents such as antioxidants and free radical scavengers can be used in hybridization mixes, and/or the hybridization and/or the wash solutions to increase the stability of Cy5™, fluors or other oxidation-sensitive compounds.

Scanning

Methods for the simultaneous detection of multiple fluorophores are well known in the art (see, e.g., U.S. Pat. Nos. 5,539,517; 6,049,380; 6,054,279; 6,055,325). For example, a spectrograph can image an emission spectrum onto a two-dimensional array of light detectors; a full spectrally resolved image of the array is thus obtained. Photophysics of the fluorophore, e.g., fluorescence quantum yield and photodestruction yield, and the sensitivity of the detector are read time parameters for an oligonucleotide array.

When using two or more fluors together, such as Cy5™ and/or Cy3™, it is important to create a composite image of all the fluors. To acquire the two or more images, the array can be scanned either simultaneously or sequentially. Charge-coupled devices (CCDs) can be used in microarray scanning systems. Alternatively, for image acquiring purpose, a laser scanner may be used instead of or in additional to a CCD camera. Other suitable image capture and/or analysis devices may also be used in the present invention. Typically, a high resolution scanner is used and analyzes the probe spots and detects shifts in color channels. For example, DNA microarray scanner manufactured by Agilent, MS200 manufactured by Nimblegen, and GenePix manufactured by Molecular Devices, and the like, can be used. Various known scanning devices or methods, or variations thereof, can be used or adapted to practice the methods of the invention, including array reading or “scanning” devices such as those described in U.S. Pat. Nos. 5,324,633; 5,578,832; 5,863,504; and 6,045,996.

### CGH Data Analysis

Data from an image can be extracted using any suitable image analysis software, such as Feature Extraction (Agilent), Matlab (Mathworks), and the like, including those modified and extended for aCGH analysis. In general, image analysis may involve one or more of the following steps: computation of the fluorescence ratio images between dye 1 and dye 2 images, normalizing signals between dye 1 and dye 2, normalizing signals against background, normalizing signals across the array to remove area related variability, calculating log ratio values for individual probes on the array, and presentation/storage of results for aberration detection.

### 1. GC Wave Correction

It has been reported that different types of arrays have “waves” in their log ratios that may be related to the GC content of the probes (Marioni et al. “Breaking the waves: improved detection of copy number variation from microarray-based comparative genomic hybridization,” Genome Biology, 2007, 8:R228). A group of probes can have a log ratio that deviates from zero. These “waves” interfere with data analysis algorithm as they skew the log ratios away from zero. With enough noise, calling algorithms can mistake these waves as deletions or amplifications. Thus, GC waves can substantially contribute to the false positive rate of aCGH.

According to the methods described herein, after data extraction, log ratios of the probes may be modified based on the GC content of individual chromosomes corresponding to each probe thus optimizing the data set for aberration detection methods. This is called GC wave correction, and it can be implemented as an algorithm executable by a computer.

Data Input

A GC wave correction algorithm typically uses two configuration files that are specific to the array design as described herein, i.e., a chromosome location file and a GC file. The chromosome location file comprises the following information about each probe in the array: the chromosome number and genome coordinates corresponding to the probe sequence (e.g., the location of the genomic sequence to which the probe is expected to hybridize). The GC file comprises the percent GC of each probe on the array. These files are specific to the design of the array and may be generated each time a new design is implemented. These files can be stored in a storage device or medium readable by a computer.

An algorithm's input data file comprises the log ratio for each probe on the array. Log ratios are read from the file, calculations are performed as described below, and the newly corrected log ratios are written back to the file.

GC Slope Determination

Log ratios are read from the sample's input data file. The probes' log ratios are compared to their percent GC with robust regression which is used to calculate the GC slope of the array. This value can be used as a quality control metric in the assay (see Quality Control Metrics section below).

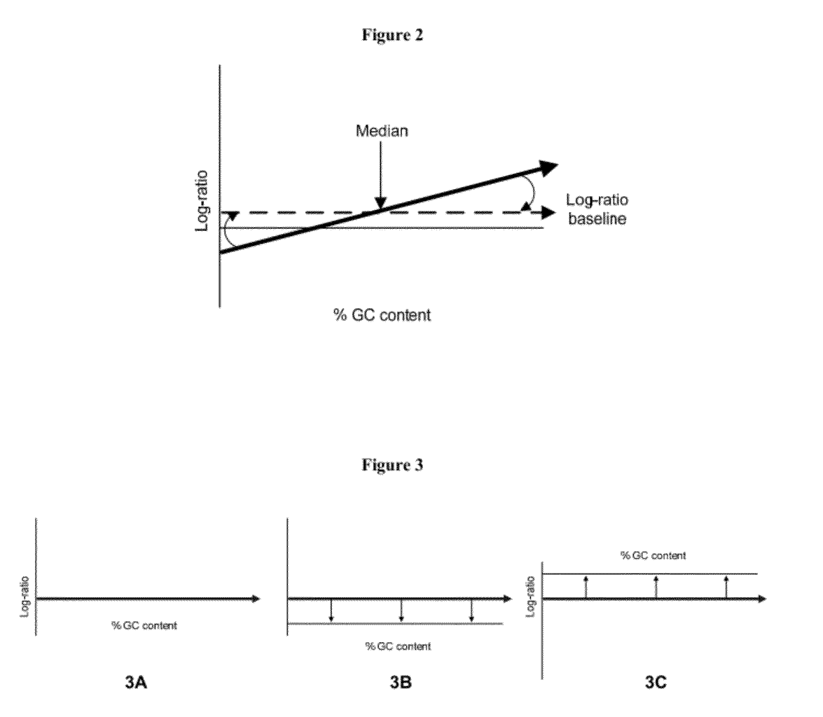

An algorithm then sorts the probe data by chromosome and uses robust regression to derive chromosomal GC slope and y-intercept data for each of the 24 chromosomes. For a particular chromosome, the GC slope m is determined by plotting the log ratio values of the probes derived from that particular chromosome against their respective GC contents (e.g., as a percentage). A line is fitted using a robust regression as shown in FIG. 2. Regression computation can be carried out using various software programs, or according to the principles set forth in Wetherill, G., (1986) Regression Analysis with Applications (Chapman and Hall, New York, 311 p) and Weslowsky, G., (1976) Multiple Regression and Analysis of Variance, (John Wiley & Sons, Toronto, 292 p). See also DuMouchel, W. H., F. L. O'Brien, (1989) “Integrating a Robust Option into a Multiple Regression Computing Environment,” Computer Science and Statistics: Proceedings of the 21st Symposium on the Interface, Alexandria, Va., American Statistical Association; Holland, P. W., R. E. Welsch (1977) “Robust Regression Using Iteratively Reweighted Least-Squares,” Communications in Statistics: Theory and Methods, A6, pp. 813-827; Huber, P. J. (1981) Robust Statistics, Wiley; Street, J. O., R. J. Carroll, D. Ruppert, (1988) “A Note on Computing Robust Regression Estimates via Iteratively Reweighted Least Squares,” The American Statistician, 42:152-154.

The slope of the trend line is taken as the GC slope (m) of the chromosome. The y-intercept of the line b is also determined for the chromosome. The algorithm determines the median GC percentage of the probes and then uses the chromosome's slope m and y-intercept b to derive the log ratio baseline for that chromosome as shown in FIG. 2 (see the dotted line in FIG. 2).

A correction factor (CorrectionFactor) for each probe i is determined according to the follow formula:

CorrectionFactorᵢ=LRBaseline−m·PercentGCᵢ−b (Eq. 1)

where m is the GC content slope of the probe's chromosome, b is the y-intercept, and LRBaseline is the baseline value for the chromosome.

The log ratio value for each individual probe i is normalized against its correction factor, i.e., the CorrectionFactorᵢ is added to the log ratio value for each individual probe i. The median log ratio of the corrected chromosome is determined based on the normalized log ratio values for individual probes and recorded for later calculations. The step can be repeated for all chromosomes. After GC slope correction, the adjusted log ratio of each probe can be compared to the baseline (e.g., 0). Possible outcomes after slope correction are depicted in FIG. 3. Some chromosomes will have a median log ratio that is close to zero. Medians for certain chromosomes may, however, be skewed. After this correction, a subset of non-aberrant chromosomes that have medians that consistently skew above or below the expected baseline throughout the dataset can require further correction (FIG. 3B, 3C). Chromosomal adjustment may then be used to further correct those skewed chromosomes.

### 2. Chromosomal Adjustment

Slope correction alone is often insufficient to fully normalize aCGH data. In order to target the genomic regions most affected by GC-waves, a second step was designed that adjusts the most consistently skewed chromosomes in a set. Without wishing to be bound by any theory, it is possible that chromosomes having skewed median log ratios may be due to unusually high/low GC content of the chromosomes or of the probes derived from those chromosomes used in the assay. In addition, it is possible that other assay conditions and format also may contribute to the skewed median log ratios. For example, gene density and repeats on certain chromosomes may affect the efficiency of the labeling of the nucleic acids from those chromosomes. DNA quality and quantity, as well as extraction method used, also may influence the reaction. Therefore, those chromosomes may be corrected by their respective chromosome adjustment factors indicative of assay-based or platform-dependent deviation from baseline (e.g., zero) for a normal diploid region.

Automated adjustments of signal data for individual chromosomes can lead to accidental removal of large chromosomal aberrations from aCGH data. This problem exists only in chromosomes that require this second adjustment step, as the first step above corrects by slope only, without taking intercept into account. To prevent this, cghSAM uses mathematical safeguards to avoid over-normalization in truly aberrant regions by ensuring that any adjustment made falls within the expected range of adjustment for a non-aberrant sample. Chromosome adjustment factors may be determined as follows.

Anchor Chromosomes

Those chromosomes to be corrected are selected from so called “anchor chromosomes.” As used herein, the term “anchor chromosomes” refers to a subset of chromosomes, each of which has a median log ratio that is skewed to the positive or negative. A median log ratio close to the baseline (e.g., zero) indicates that there is little difference between the reference sample and the test sample. The anchor chromosome are selected from those chromosomes that have median log ratios that are most skewed from zero, either higher or lower. Typically, the set of anchor chromosomes is platform- and/or assay-dependent and should be derived from a statistically significant data set (i.e., the number, percentage, and/or identity of the anchor chromosomes may be different depending on the type of assay used or clinical determination being made). For example, archived historical data obtained using a particular platform and/or a particular set of assay conditions can be used to derive anchor chromosomes for that particular platform and assay format.

In some embodiments, a set of anchor chromosomes can be chosen by examining multiple median log ratio values (typically GC wave corrected) of all relevant chromosomes (e.g., all autosomal chromosomes) generated from multiple samples using the same platform and/or assay conditions, and a subset of chromosomes whose medians were the furthest from zero are chosen as anchor chromosomes. For example, in one embodiment, as described in Example 2, a set of 9 anchor chromosomes, including chromosomes 3, 4, 5, 6, 13, 16, 17, 19 and 22, were chosen based on 27 historical samples. In some embodiments, at least one of these chromosomes is selected as an anchor chromosome. In other experiments, a different set of anchor chromosomes may be chosen depending on, for example, the platform used, the GC contents of the probes, the type of disease to be detected, and/or the assay conditions. In general, the number of anchor chromosomes may represent about 30%, 35%, 40%, or 45% of the total number of chromosomes. In some embodiments, a set of anchor chromosomes may contain about 4, 5, 6, 7, 8, 9, 10, 11, or 12 chromosomes. In other embodiments, fewer or more anchor chromosomes may be used as described in detail herein. In one embodiments, a set of anchor chromosomes may contain about 7, 8, 9, or 10 chromosomes. Any chromosome can be an anchor chromosome depending on, for example, the platform used and assay conditions. In certain embodiments, an autosomal chromosome is chosen as an anchor chromosome. A set of anchor chromosomes, once chosen, will be used to anchor the chromosomal adjustment values. The selected chromosomes form the anchor set A with the anchor values a₁, . . . , a_{N}.

Anchor Values

In some embodiments, anchor values indicative of relative deviation from baseline (e.g., 0) are first calculated for each individual anchor chromosomes. Typically, the “most skewed” anchor chromosome, i.e., the anchor chromosome whose median log ratio is most skewed from 0 is first identified (the most skewed anchor chromosomes become the “outlier chromosomes” described in further detail below). The anchor value aᵢ for a particular anchor chromosome j can then be determined by comparing the median log ratios of anchor chromosome j to the median log ratios of the “most skewed” anchor chromosome. For example, median log ratio values (after GC correction) for a given anchor chromosome j can be plotted against the median log ratio values of the most skewed anchor chromosome for all the historical samples. The anchor value for the given chromosome (e.g., chromosome j) is defined as the slope of the trend line (calculated using robust regression) from the datasets. This process may be repeated for all other anchor chromosomes to obtain the set of anchor values. The anchor value for the most skewed chromosome is 1. Exemplary anchor values are provided in Example 3.

Outlier Chromosomes

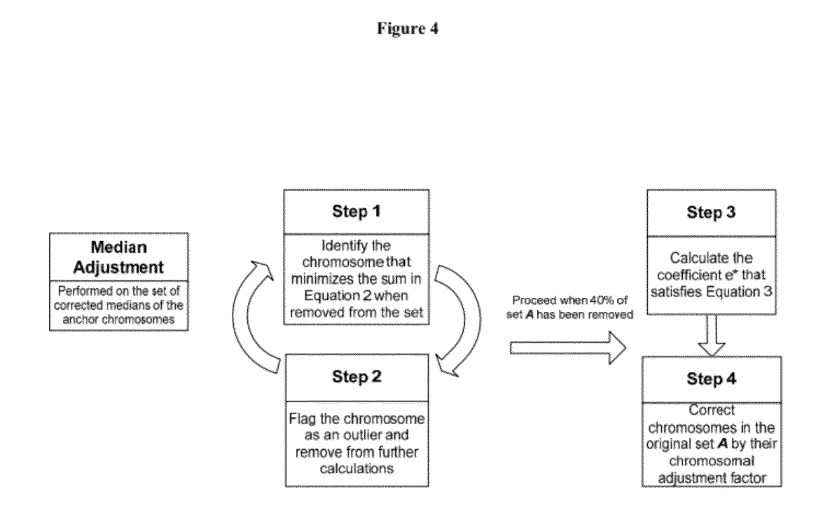

Typically, “outlier chromosomes” are removed from the set of anchor chromosomes before calculating chromosomal adjustment factors to minimize false negatives (FIG. 4). As used herein, the phrase “outlier chromosomes” refers to those chromosomes whose median log ratios skew the furthest among the anchor chromosomes. It is contemplated that the median log ratios for the outlier chromosomes may be so skewed that they may potentially contain copy number changes or other genomic aberrations. Those outlier chromosomes are removed from the anchor set so that they do not contribute to the calculation of the adjustment factor e (see Eq. 2). In some embodiments, 30%, 35%, 40%, or 45% of the anchor chromosomes can be designated as outlier chromosomes. The selection of the outlier chromosomes is discussed below. After excluding the outliers, the remaining anchor chromosomes are used to calculate the chromosomal adjustment factors. In some embodiments, 70%, 65%, 60%, or 55% of the anchor chromosomes are selected to calculate the chromosomal adjustment factors.

Various methods can be used to exclude outlier chromosomes. In some embodiments, a least-squares fit analysis is performed to identify outlier chromosomes. In some embodiments, a least-squares fit analysis suitable for the invention is based on the sample summation according to equation 1:

$$min {\sum }_{j = 1}^{x} {( {a}_{j} - e \cdot {m}_{j} )}^{2} \qquad ( Eq . 2 )$$

wherein aⱼ is the anchor value for individual anchor chromosome j and mⱼ is the normalized median log ratio value for individual anchor chromosome j in a given sample assay. For example, the sample summation is calculated for the set of x anchor chromosomes, each time omitting one chromosome in the set, such that each anchor chromosome in the set is omitted once during calculation. A chromosome is identified as an outlier if its omission results in the smallest summation and is removed from the set of chromosomes in the next round of calculations. The remaining (x−1) chromosomes are then recursively searched (again using the least squares analysis) for the next outlier. This process is repeated until a pre-determined number of outlier chromosomes are excluded.

Median Adjustment

After outlier chromosomes are removed, the cghSAM algorithm finds a coefficient e* such that the difference between the anchor values a and e*·m for the remaining anchor chromosomes is minimized according to Equation 2 above. The chromosomal adjustment factors for the sample are then defined as a/e*, that is, the adjustment factor for each anchor chromosome j is a/e*. To perform chromosomal adjustment (also referred to as median adjustment) for the sample, all anchor chromosomes' log ratios are corrected by their respective chromosomal adjustment factor. For example, the log ratios for anchor chromosome j are corrected by subtracting aⱼ/e* from the log ratios for individual probes derived from anchor chromosome j.

$${e}^{*} = arg min {\sum }_{j = 1}^{M} {( {a}_{j} - e \cdot {m}_{j} )}^{2} \qquad ( Eq . 3 )$$

Resulting adjusted log ratios are written back to the sample's file, and an output file is generated for aberration detection.

An exemplary flowchart illustrating exemplary steps for chromosomal adjustment is shown in FIG. 4.

### 3. Quality Control Metrics

Quality control metrics may be implemented during the process to eliminate failed samples and/or to ensure that unnecessary adjustment is not performed on the sample data set.

GC Slope of Array

As described above, for each sample, the algorithm uses robust regression to calculate the GC slope of the entire array. The introduction of GC content slope as a QC metric affords a way to flag and remove those samples that will not perform well in the assay. Specifically, the probes' log ratios are plotted against their respective percent GC and a trend line is fitted using a robust regression. The slope of the trend line is then calculated and compared to a pre-defined threshold. The QC procedure checks if the sample's slope exceeds the pre-defined threshold, in which case the sample is failed. Typically, this QC step is carried out before GC wave correction is performed.

Sample Summation Criteria

In some embodiments, after the outlier chromosomes are excluded, the summation is obtained for the remaining anchor chromosomes that are used for calculating chromosomal adjustment factors according to Equation 2 above (the summation is based on e* described above). This summation is also referred to as the sample's summation. Before the chromosomal adjustment is performed, the sample's summation is compared to a pre-defined threshold. The QC procedure checks if the sample's summation is higher than the pre-defined threshold, in which case the sample does not undergo chromosomal adjustment.

### Systems, Computer Readable Mediums and Kits

Typically, the methods of the invention can be implemented on systems or computer readable mediums. In some embodiments, the invention provides systems for aCGH data analysis, comprising one or more of:

a) means to receive log ratio values for an array of probes hybridized to a genome of a test sample and a genome of a reference sample, wherein the reference sample has a known ploidy, wherein each individual probe has a known chromosome location and a pre-determined GC content;

b) a storage device configured to store data comprising (i) the chromosome location and pre-determined GC content for each individual probe, (ii) GC content for each chromosome, and (iii) anchor values for pre-determined anchor chromosomes indicative of assay-dependent deviation;

c) a determination module configured to determine a log ratio base line for each chromosome based on the GC content of the chromosome;

d) a computing module adapted to (i) normalize the log ratio value for each individual probe against the log ratio baseline of the corresponding chromosome from which the individual probe is derived; (ii) calculate median log ratios for individual chromosomes based on the normalized log ratio value for individual probes, (iii) select a subset of anchor chromosomes by excluding outlier chromosomes whose median log ratios skew the furthest among the anchor chromosomes based on the anchor values and the normalized median log ratios for each anchor chromosome; (iv) calculate chromosomal adjustment factors indicative of assay-based deviation from baseline (e.g., 0) based on the subset of anchor chromosomes selected at step (iii) and/or normalize the anchor chromosomes' log ratio values against their respective chromosomal adjustment factors; (v) determine the quality of GC slope and/or the chromosomal adjustment factors to determine if the correction should be made; and

e) a second storage device configured to store an output file comprising corrected log ratio values for individual probes for aberration detection.

In some embodiments, an inventive system further comprises means to carry out aberration detection.

Systems provided herein can, in some embodiments, be described as functional modules, clients, agents, programs, executable instructions or instructions included on a computer readable medium such that a processor can execute the instructions to perform a method or process described herein. The functional modules described herein need not correspond to discreet blocks of code. Rather, functional portions of the functional modules can be carried out by the execution of various code portions stored on various media and executed at various times. Furthermore, it should be appreciated that the modules may perform other functions, thus the modules are not limited to having any particular functions or set of functions. In some embodiments, these functional modules can be executed by a computing device. The functional modules can be stored on the computing device, or in some embodiments can be stored on an external storage repository or remote computing machine.

In some embodiments, the present invention provides a computer readable medium having anchor values recorded thereon for anchor chromosomes pre-determined to have skewed median log ratios that deviate from baseline (e.g., 0) in normal diploid regions in a predetermined aCGH assay, wherein the anchor value aⱼ for each individual anchor chromosome j is defined by a slope of a trend line defined by plotting archived median log ratios obtained using the pre-determined CGH assay of chromosome j against archived median log ratios of the anchor chromosome that was most skewed from baseline (e.g., 0).

In some embodiments, the present invention provides a computer readable medium having one or more of configuration files that are specific to an array design described herein. A computer readable medium may comprise a chromosome location file containing information relating to the chromosome number and genome coordinates corresponding to individual probe sequence (e.g., the location of the genomic sequence to which the probe is expected to hybridize); and/or a GC file containing the percent GC of each probe on the array.

The invention also contemplates various kits for carrying out the inventive methods described herein. In some embodiments, the present invention provides a kit containing one or more of the following: (a) an array of probes for CGH analysis, wherein each individual probe has a known chromosome location and a pre-determined GC content; (b) one or more computer-readable mediums containing information relating to anchor chromosomes and anchor values, array-specific configuration files such as the chromosome location file and GC file as described herein; (c) one or more reagents for conducting a pre-determined aCGH assay. In some embodiments, a kit of the invention also comprises a reference sample with a known ploidy or a reference data set indicative of signals of the array of probes hybridized to a reference sample with a known ploidy.

### Clinical Applications

Inventive methods and systems according to the present invention can be used to detect any genomic aberrations and associated genetic diseases, disorders, and conditions and are particularly useful in pre-natal or post-natal diagnosis and/or carrier tests. Inventive methods and systems also can be used to formulate appropriate treatment plans and/or facilitate a prognosis. In some embodiments, the present invention can be used in situations where the causality, diagnosis or prognosis of the pathology or condition is associated with one or more genetic defects such as nucleic acid base substitutions, amplifications, deletions, and/or translocations. In some embodiments, the present invention can be used to detect chromosome abnormalities including, but not limited to, structural abnormalities, aneuploidy polyploidy, trisomy, and the like) and mosaics, and associated genetic diseases, disorders, and conditions. For example, a missing copy of chromosome X (monosomy X) results in Turner's Syndrome, while an additional copy of chromosome 21 results in Down Syndrome. Other diseases such as Edward's Syndrome and Patau Syndrome are caused by an additional copy of chromosome 18, and chromosome 13, respectively. The present method may be used for detection of a translocation (e.g., imbalanced translocation), addition, amplification, transversion (e.g. imbalanced transversion), inversion (e.g. imbalanced inversion), aneuploidy, polyploidy, monosomy, trisomy including but not limited to trisomy 21, trisomy 13, trisomy 14, trisomy 15, trisomy 16, trisomy 18, trisomy 22, triploidy, tetraploidy, and sex chromosome abnormalities including but not limited to XO, XXY, XYY, and XXX.

In addition, the present invention can be used to analyze genetic aberrations associated with any genetic loci such as genes or portions thereof (e.g., exons, introns, promoters, or other regulatory regions). Table 1 lists non-limiting examples of such genes and associated genetic diseases, disorders, or conditions. As understood by one of ordinary skill in the art, a gene may be known by more than one name. The listing in Table 1 does not exclude the existence of additional genes that may be associated with a particular disease. The present invention encompasses those additional genes, including those that will be discovered in the future associated with each particular diseases.

TABLE 1
Exemplary genes associated with genetic diseases, disorders or conditions

| Disease, Disorder or condition | Gene | Protein Product |
|---|---|---|
| Achondroplasia | FGFR3 | fibroblast growth factor receptor 3 |
| Adrenoleukodystrophy | ABCD1 | ATP-binding cassette (ABC) |
| | | transporters |
| Alpha-1-antitrypsin deficiency | SERPINA1 | serine protease inhibitor |
| Alpha-thalassemia | HBA 1&2 | hemoglobin alpha 1&2 |
| Alport syndrome | COL4A5 | collagen, type IV, alpha 5 |
| Amyotrophic lateral sclerosis | SOD1 | superoxide dismutase 1 |
| Angelman syndrome | UBE3A | ubiquitin protein ligase E3A |
| Ataxia telengiectasia | ATM | ataxia telangiectasia mutated |
| Autoimmune polyglandular | AIRE | autoimmune regulator |
| syndrome | | |
| Bloom syndrome | BLM, RECQL3 | recQ3 helicase-like |
| Burkitt lymphoma | MYC | v-myc myelocytomatosis viral |
| | | oncogene homolog |
| Canavan disease | ASPA | aspartoacylase |
| Congenital adrenal hyperplasia | CYP21 | cytochrome P450, family 21 |
| Cystic fibrosis | CFTR | cystic fibrosis transmembrane |
| | | conductance regulator |
| Diastrophic dysplasia | SLC26A2 | sulfate transporter |
| Duchenne muscular dystrophy | DMD | Dystrophin |
| Familial dysautonomia | IKBKAP | IKK complex-associated protein |
| | | (IKAP) |
| Familial Mediterranean fever | MEFV | Mediterranean fever protein |
| Fanconi anemia | FANCA, FANCB | (proteins involved in DNA repair) |
| | (FAAP95), FANCC, | |
| | FANCD1 (BRCA2), | |
| | FANCD2, FANCE, | |
| | FANCF, FANCG, | |
| | FANCI, FANCJ | |
| | (BRIP1), FANCL | |
| | (PHF9 and POG), | |
| | FANCM (FAAP250) | |
| Fragile X syndrome | FMR1 | fragile X mental retardation 1 |
| Friedrich's ataxia | FRDA | Frataxin |
| Gaucher disease | GBA | glucosidase |
| Glucose galactose malabsorption | SGLT1 | sodium-dependent glucose |
| | | cotransporter |
| Glycogen disease type I (GSD1) | G6PC (GSDIa) | glucose-6-phosphatase |
| | SLC37A4 | glucose-5-phosphate transporter 3, |
| | (GSDIb) | solute carrier family 37 member 4 |
| Gyrate atrophy | OAT | crnithine aminotransferase |
| Hemophilia A | F8 | hoagulation factor VIII |
| Hereditary hemocrhomatosis | HFE | hemochromatosis protein |
| Huntington disease | HD | Tuntingtin |
| Immunodeficiency with hyper-IgM | TNFSF5 | humor necrosis factor member 5 |
| Lesch-Nyhan syndrome | HPRT1 | hypoxanthine phosphoribotransferase |
| Maple syrup urine disease | BCKDHA | branched chain keto acid |
| (MSUD) | | dehydrogenase |
| Marfan syndrome | FBN1 | Fibrillin |
| Megalencephalic | MLC1 | (putative transmembrane protein) |
| leukoencephalopathy | | |
| Menkes syndrome | ATP7A | ATPase Cu++ transporting |
| Metachromatic leukodystrophy | ARSA | arylsulfatase A |
| (MLD) | | |
| Mucolipidosis IV (ML IV) | MCOLN1 | Mucolipin-1 |
| Myotonic dystrophy | DMPK | myotonic dystrophy protein kinase |
| Nemaline myopathy | | |
| Neurofibromatosis | NF1, NF2 | neurofibromin |
| Niemann Pick disease (types A | SMPD1 | sphingomyelin phosphodiesterase 1, |
| and B type) | | acid lysosomal (acid |
| | | sphingomyelinase) |
| Niemann Pick disease (type C) | NPC1, NPC2 | Niemann-Pick disease, type C1 (an |
| | | integral membrane protein) and |
| | | Niemann-Pick disease, type C2 |
| Paroxysmal nocturnal | PIGA | phosphatidylinositol glycan |
| hemoglobinuria | | |
| Pendred syndrome | PDS | Pendrin |
| Phenylketonuria | PAH | phenylalanine hydroxylase |
| Refsum disease | PHYH | Phytanoyl-CoA hydroxylase |
| Retinoblastoma | RB | retinoblastoma 1 |
| Rett syndrome | MECP2 | methyl CpG binding protein |
| SCID-ADA | ADA | adenosine deaminase |
| (Severe combined | | |
| immunodeficiency-ADA) | | |
| SCID-X-linked | IL2RG | Interleukin-2-receptor, gamma |
| (Sever combined | | |
| immunodeficiency-X-linked) | | |
| Sickle cell anemia (also known as | HBB | hemoglobin, beta |
| beta-thalassemia) | | |
| Spinal muscular atrophy (SMA) | SMN1, | survival of motor neuron 1, |
| | SMN2 | Survival of motor neuron 2 |
| Tangier disease | ABCA1 | ATP-binding cassette A1 |
| Tay-Sachs disease | HEXA | hexosaminidase |
| Usher syndrome | MYO7A | myosin VIIA |
| (Also known as Hallgren | USH1C | Harmonin |
| syndrome, Usher-Hallgren | CDH23 | cadherin 23 |
| syndrome, rp-dysacusis syndrome | PCDH15 | protocadherin 15 |
| and dystrophia retinae dysacusis | USH1G | SANS |
| syndrome.) | USH2A | Usherin |
| | GPR98 | VLGR1b |
| | DFNB31 | Whirlin |
| | CLRN1 | clarin-1 |
| Von Hippel-Lindau syndrome | VHL | elongin binding protein |
| Werner syndrome | WRN | Werner syndrome protein |
| Wilson's disease | ATP7B | ATPase, Cu++ transporting |
| Zellweger syndrome | PXR1 | peroxisome receptor 1 |

In addition to the genes listed in Table 1, methods disclosed herein are suitable for analyzing copy numbers at loci with such copy number variants. The Database of Genomic Variants, which is maintained at the website whose address is “http://” followed immediately by “projects.tcag.ca/variation” (the entire contents of which are herein incorporated by reference), lists more than at least 38,406 copy number variants (as of Mar. 11, 2009). (See, e.g., Iafrate et al. (2004) “Detection of large-scale variation in the human genome” Nature Genetics. 36(9):949-51; Zhang et al. (2006) “Development of bioinformatics resources for display and analysis of copy number and other structural variants in the human genome.” 115(34):205-14; Zhang et al. (2009) “Copy Number Variation in Human Health, Disease and Evolution,” Annual Review of Genomics and Human Genetics. 10:451-481; and Wain et al. (2009) “Genomic copy number variation, human health, and disease.” Lancet. 374:340-350, the entire contents of each which are herein incorporated by reference).

Although most genes are normally present in two copies per genome equivalent, a large number of genes have been found for which copy number variations exist between individuals. Copy number differences can arise from a number of mechanisms, including, but not limited to, gene duplication events, gene deletion events, gene conversion events, gene rearrangements, chromosome transpositions, etc. Differences in copy numbers of certain genes may have implications including, but not limited to, risk of developing a disease or condition, likelihood of progressing to a particular disease or condition stage, amenability to particular therapeutics, susceptibility to infection, immune function, etc.

### EXAMPLES

### Example 1

### Array-Based Comparative Genomic Hybridization

Microarray-based CGH (aCGH) techniques have revolutionized the field of chromosomal structural variation detection. They are capable of higher resolution than karyotyping, FISH (fluorescence in situ hybridization), SKY (spectral karyotyping) and other techniques and are particularly useful for detection of copy number changes in genetic disorders. In this example, a 60-mer oligonucleotide array was synthesized in situ using inkjet technologies. This array was designed to cover the entire genome with greatly enhanced coverage at known clinically relevant regions. Clinical samples were tested for known microdeletion and/or microduplication syndromes, all subtelomeric and pericentromeric regions, and other clinically significant genomic imbalances covered by the array.

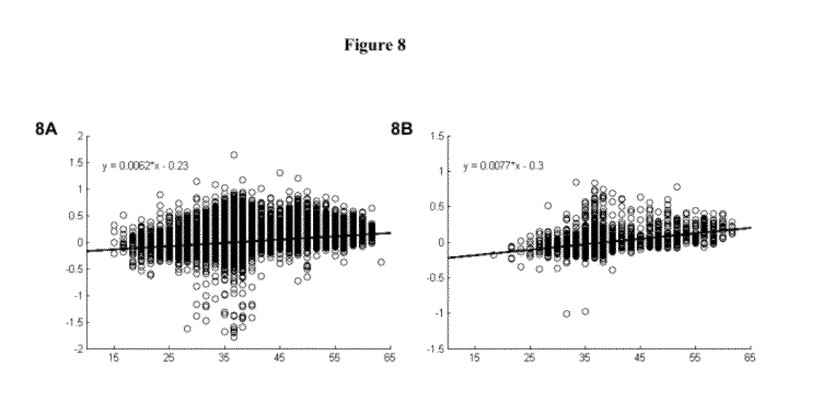

The array was 4×44K format; that is, there were 4 arrays per slide with approximately 44,000 probes per array. (In another embodiment, the results of which are shown in FIG. 8, an 180K array from Agilent was used.) Each probe had a known chromosome location, and its GC content was also determined and recorded to generate two array-specific configuration files: the chromosome location file containing the information about the chromosome number and genome coordinates of each probe sequence (i.e., the location of the genomic sequence to which the probe is expected to hybridize); and the GC file containing the percent GC of each probe on the array.

The methodologies used in this example generally included the following: DNA extraction from whole blood, restriction enzyme digestion, labeling patient DNA with Cy-5 and pooled, sex-matched normal reference DNA with Cy-3, removal of unincorporated dyes, prehybridization, and hybridization onto a glass microarray slide followed by washing to remove nonspecific hybridization before reading slide fluorescence on a DNA microarray scanner (Agilent).

DNA Preparation and Labeling

DNA was extracted from whole blood samples using, e.g., the Qiagen TLOW protocol plus an RNase digestion step (TRNase extraction method) and then quantified. All array analyses were performed with either gender-matched or gender-mismatched reference DNA pooled from 6 phenotypically normal individuals (Promega, Madison, Wis.). The procedures for digestion, labelling, purification, and hybridization were performed in accordance with the manufacturer's suggested protocols, with slight modifications. Briefly, 500 ng patient DNA and a corresponding reference DNA were digested with AluI (units) and RsaI (units) (Promega, Madison, Wis.) for 2 hours. The plates were denatured for 5 minutes in a thermal cycler at 95° C. and then chilled on ice for 5 minutes.

The labelling reaction was performed using the Agilent Enzymatic Genomic DNA Labelling Kit (Agilent Technologies, Santa Clara, Calif.) using either Cy5-dUTP (patient DNA) or Cy3-dUTP (reference DNA). Labeling reactions were carried out in a final volume of 50 μl, using a thermal cycler. Length of time in thermal cycler was approximately 2 hours, 10 minutes.

After the labeling reactions, the samples were pooled and purified using YM30 size separation spin columns (check, Microcon, location). The purified samples were incubated with human Cot-1 DNA, as well as a blocking agent (Agilent Technologies, Santa Clara, Calif.) and hybridization buffer (Agilent Technologies, Santa Clara, Calif.). The hybridization mixture was hybridized to a microarray. Hybridization occurred in a rotating oven set at 65° C. over 20-24 hours. The slides were washed using a Little Dipper wash station (SciGene, location). Enzymatic digestion was performed for each sample once using, e.g., RsaI and AluI (Promega).

Prehybridization, Hybridization and Washing

Purified labeled nucleic acids were incubated in prehybridization buffer using human Cot-1 DNA for approximately 30 minutes or more. For hybridization, specimens were loaded onto corresponding positions of a gasket slide. The microarray slide was then placed onto the gasket slide and the hybridization chamber sealed. The chambers were hybridized at approximately 65° C. for between approximately 22 and approximately 24 hours while being rotated gently (e.g., 20 rpm). After hybridization, slides were disassembled and washed using, e.g., the Little Dipper™ Wash Station.

Scanning, Data Analysis and Results

Following centrifugation, slides were loaded into holders and read using a DNA microarray scanner (e.g., Agilent DNA microarray scanner). A high resolution (e.g., 5 μm) scan was performed on each microarray slide to analyze the probe spots and detect shifts in the color channels. Scanned .tif images were imported into extraction software (e.g., Feature Extraction software (Agilent)) and data from the image were then extracted, normalized, and converted into log ratio values for each probe on the array. This analysis was performed using the Feature Extraction (v 9.5.3) (Agilent Technologies, Santa Clara, Calif.) and DNA Analytics (v 4.0.76) (Agilent Technologies, Santa Clara, Calif.) software packages. Aberrations were called in DNA Analytics using the ADM2 aberration detection algorithm (see Table 2 for settings).

TABLE 2
Settings used by DNA microarray scanner
for analysis of sample data.

| Program Attribute | Details |
|---|---|
| Feature Extraction Version | 9.5.3.1 |
| Feature Extraction Protocol | CGH-v4_95_Feb07 |
| DNA Analytics Version | 4.0.76 |
| DNA Analytics Fuzzy Zero | Not applied |
| DNA Analytics Centralization | Threshold - 6, Bin size - 10 |
| DNA Analytics Algorithm - ADM2 | Threshold - 12.9, With |
| | cghSAM - 10.4 |
| DNA Analytics Minimum number of probes | 7 |
| DNA Analytics Minimum log-ratio | 0.40 |

GC Wave Correction

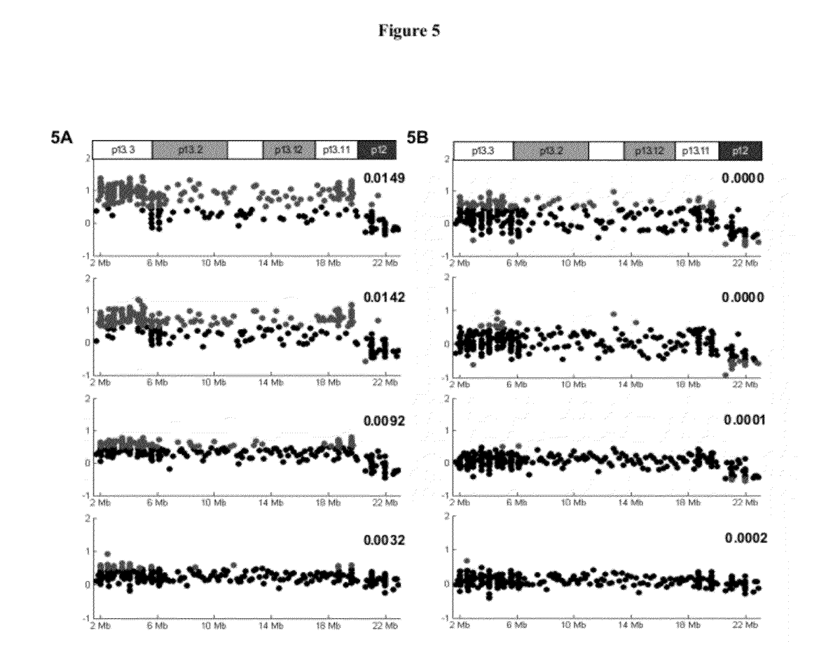

As discussed above, aCGH platforms have waves in their log ratios that may be correlated to the GC content of the probes on the array. These waves interfere with data analysis algorithms as they skew the log ratios away from zero, increasing the potential for false positive aberration calls. Examples of wave effects of different magnitudes in 4 samples across a region of chromosome 19 are shown in FIG. 5.

The microarray data generated from the blood samples were analyzed using a specific embodiment of the method which is an algorithm called cgh Slope and Anchored Median (cghSAM). The cghSAM algorithm uses normalized log-ratio signal intensities from two DNA samples involved in comparative hybridization either in silico or experimentally. Step one is a data slope correction that is based on linear regression of log-ratio signal intensities to the probe GC-content. Exemplary GC slopes determined for 4 different samples are shown in Table 3. Since the GC slope of the whole array is different than the GC slope of the individual chromosomes, slope correction is performed on a chromosomal basis to avoid over correction. Chromosomes listed in Table 3 are 2, 10, 13, and 17. Step two is a chromosome-wide normalization of the residual log-ratio bias based on historical chromosomal signal ratio medians.

TABLE 3
Exemplary GC Slope for Array and Chromosomes

| | GC Slope | GC Slope for Individual Chromosomes | | | |
|---|---|---|---|---|---|
| Sample 1 | 0.0149 | 0.0087 | 0.0109 | 0.0108 | 0.0109 |
| Sample 2 | 0.0142 | 0.0106 | 0.0115 | 0.0127 | 0.0111 |
| Sample 3 | 0.0092 | 0.0068 | 0.0066 | 0.0084 | 0.0061 |
| Sample 4 | 0.0032 | 0.0019 | 0.0020 | 0.0024 | 0.0019 |

The cghSAM algorithm was implemented in Matlab (Mathworks, Inc.) and tested on an Agilent 4×44 k (Agilent Technologies, Inc.) custom microarray. To evaluate algorithm performance, aberration calling performance before and after algorithm correction on 218 arrays were compared. The specificity and sensitivity of the array was quantified by comparing aberration calls made before and after correction and by using data generated at a common polymorphic locus. Most importantly, correction by cghSAM could not eliminate any aberration calls that had been called in the assay pre-correction and had been confirmed by cytogenetic methods. In the entire validation dataset, no cytogenetically confirmed calls were lost post-correction.

To further understand the performance of the algorithm, a well-characterized copy number polymorphic locus, GSTT1, also was examined. In this locus, a copy number change from 1 reference to 2 sample copies was observed in 74 patients. Before cghSAM correction, 26 of these aberrations were detected. After correction, 51 of these aberrations were detected, an improvement in the detection of small 1-2 copy number changes of 33.8%. Correction performance in regards to assay specificity was also examined. In sixteen samples (7.4%) where copy number changes were shown to be false positives by cytogenetics, the correction eliminated false positive aberration calls in twelve of the samples. The remaining four false positive samples (1.9%), would have failed the genome-wide GC-slope QC metric, which were implemented as a result of cghSAM development.

The cghSAM algorithm improved the overall sensitivity and specificity of the array, without any loss of sensitivity to clinically relevant aberrations. The improvement in sensitivity in calling small regions can partially be attributed to the more permissive calling threshold enabled by the reduction in wave amplitude, but the simultaneous increase in specificity would not be seen unless cghSAM was effectively reducing the GC waves in the data.

### Example 2

### Selection of Anchor Chromosomes

In this example, a set of anchor chromosomes were determined based on archived log ratio values from 27 historical samples obtained using a pre-determined platform and under predetermined assay conditions. Specifically, data from 27 samples run under the same conditions were extracted and GC correction was performed using the algorithm described above. For each sample, the median log ratio of each chromosome after correction was recorded. Table 4 shows GC corrected median log ratio values for 22 autosomal chromosomes from 27 samples.

TABLE 4
Exemplary GC corrected median log ratio values

| Sample | Chr 1 | Chr 2 | Chr 3 | Chr 4 | Chr 5 | Chr 6 | Chr 7 | Chr 8 | Chr 9 | Chr 10 | Chr 11 |
|---|---|---|---|---|---|---|---|---|---|---|---|
| 1 | −0.00514 | −0.00484 | −0.0093 | −0.0157 | −0.00949 | −0.00553 | −0.00936 | −0.0077 | −0.00184 | −0.00212 | −0.00256 |
| 2 | −0.00898 | −0.02096 | −0.03315 | −0.04359 | −0.03631 | −0.0333 | −0.01527 | −0.0259 | −0.01102 | −0.0039 | −0.00676 |
| 3 | −0.01361 | −0.02939 | −0.04415 | −0.05731 | −0.04593 | −0.05084 | −0.01928 | −0.03381 | −0.00869 | −0.00419 | −0.00875 |
| 4 | −0.00654 | −0.021 | −0.0337 | −0.03271 | −0.04378 | −0.03523 | −0.01371 | −0.03588 | −0.00676 | −0.00068 | −0.00479 |
| 5 | −0.00123 | −0.01877 | −0.0321 | −0.04615 | −0.05667 | −0.03717 | −0.01096 | −0.02486 | 0.000754 | 0.003361 | −0.00227 |
| 6 | −0.00598 | −0.02303 | −0.03626 | −0.05056 | −0.04182 | −0.03774 | −0.01434 | −0.03284 | −0.00558 | −0.00181 | −0.00836 |
| 7 | −0.02916 | −0.03967 | −0.04633 | −0.052 | −0.04464 | −0.05055 | −0.0319 | −0.0356 | −0.02567 | −0.02454 | −0.02155 |
| 8 | 0.00011 | −0.0155 | −0.02689 | −0.04536 | −0.04851 | −0.02909 | −0.00904 | −0.02091 | 0.001052 | 0.004821 | 0.00053 |
| 9 | −0.00961 | −0.01483 | −0.01797 | −0.02041 | −0.01803 | −0.01648 | −0.01322 | −0.0148 | −0.00962 | −0.00823 | −0.00937 |
| 10 | 0.008378 | −0.0016 | −0.00798 | −0.01632 | −0.01276 | −0.00707 | 0.005926 | −0.01202 | 0.097191 | 0.012181 | 0.00324 |
| 11 | −0.00112 | −0.00246 | −0.00213 | −0.02353 | −0.01831 | 0.002174 | −0.00661 | −0.0225 | 0.001544 | 0.00653 | 0.004338 |
| 12 | −0.00307 | −0.00397 | −0.00585 | −0.00924 | −0.00646 | −0.00326 | −0.00728 | −0.00277 | −0.00136 | −0.00203 | −0.00036 |
| 13 | −0.00234 | −0.00183 | −0.00574 | −0.02223 | −0.0152 | −0.00149 | −0.00364 | −0.02316 | 7.97E−05 | 0.003441 | 0.002509 |
| 14 | −0.0139 | −0.02535 | −0.03508 | −0.05037 | −0.0374 | −0.03666 | −0.01819 | −0.04384 | −0.00891 | −0.00187 | −0.00394 |
| 15 | −0.02673 | 0.04765 | −0.06277 | −0.08654 | −0.06486 | −0.06827 | −0.03918 | −0.05421 | −0.01524 | −0.01098 | −0.00414 |
| 16 | −0.00629 | −0.01392 | −0.02166 | −0.02783 | −0.02431 | −0.02163 | −0.00753 | −0.02243 | −0.00418 | −0.00293 | −0.00934 |
| 17 | −0.00677 | −0.01413 | −0.02237 | −0.03138 | −0.02595 | −0.02218 | −0.00878 | −0.02341 | −0.00407 | −0.00262 | −0.0102 |
| 18 | 0.005716 | −0.0042 | −0.01482 | −0.0245 | −0.01794 | −0.01339 | 0.001025 | −0.01442 | 0.008658 | 0.009143 | 0.001375 |
| 19 | −0.01623 | −0.02566 | −0.03116 | −0.05438 | −0.04546 | −0.02614 | −0.02762 | −0.04853 | −0.01781 | −0.0091 | −0.01563 |
| 20 | −0.00407 | −0.01238 | −0.02341 | −0.03475 | −0.02741 | −0.01826 | −0.01144 | −0.02255 | −0.00515 | −0.00047 | −0.00598 |
| 21 | −0.00394 | −0.01562 | −0.02621 | −0.03508 | −0.0274 | −0.02621 | −0.0097 | −0.01984 | −0.00341 | 0.001593 | −0.00492 |
| 22 | −0.00682 | −0.0192 | −0.02693 | −0.0287 | −0.02671 | −0.03189 | −0.01162 | −0.01674 | −0.0017 | −0.0486 | −0.00856 |
| 23 | −0.00582 | −0.01646 | −0.02592 | −0.03854 | −0.02957 | −0.02499 | −0.01147 | −0.02463 | −0.00472 | −0.00069 | −0.00419 |
| 24 | −0.00639 | −0.02221 | −0.03331 | −0.04763 | −0.0375 | −0.03521 | −0.01771 | −0.02723 | −0.00793 | −0.00157 | 0.000796 |
| 25 | −0.0007 | −0.00419 | −0.00673 | −0.01192 | −0.01107 | −0.00725 | −0.00322 | −0.00971 | 0.000786 | 0.001526 | −0.00097 |
| 26 | 0.006552 | −0.00581 | −0.01377 | −0.02265 | −0.01609 | −0.01214 | −0.00149 | −0.01294 | 0.005209 | 0.007366 | 0.001906 |
| 27 | −0.00098 | −0.00841 | −0.01247 | −0.02671 | −0.01704 | −0.01182 | −0.00731 | −0.01125 | −3.39E−05 | 0.004102 | 0.002347 |
| Median | −0.00582 | −0.0155 | −0.02592 | −0.03475 | −0.0274 | −0.02499 | −0.01096 | −0.02255 | −0.00407 | −0.00157 | −0.00414 |
| Average | −0.0061 | −0.01604 | −0.02438 | −0.03615 | −0.02987 | −0.0245 | −6.01196 | −0.02387 | −0.00438 | −0.00106 | −0.00428 |

| Sample | Chr 12 | Chr 13 | Chr 14 | Chr 15 | Chr 16 | Chr 17 | Chr 18 | Chr 19 | Chr 20 | Chr 21 | Chr 22 |
|---|---|---|---|---|---|---|---|---|---|---|---|
| 1 | −0.00198 | −0.00745 | −0.00629 | −0.00263 | −0.0005 | 0.008992 | −0.00127 | −0.00173 | −0.00073 | 0.1619 | −0.00496 |
| 2 | −0.00356 | −0.03086 | −0.01072 | −0.09343 | 0.0317 | 0.054332 | −0.01869 | 0.062506 | 0.009268 | −0.01778 | 0.043765 |
| 3 | −0.00981 | −0.0448 | −0.1381 | −0.00508 | 0.046651 | 0.070621 | −0.02968 | 0.080401 | 0.011416 | −0.02608 | 0.065346 |
| 4 | −0.00552 | −0.03261 | −0.00779 | −0.00677 | 0.03641 | 0.064573 | −0.01994 | 0.066972 | 0.00981 | −0.02321 | 0.055294 |
| 5 | −0.00473 | −0.03334 | −0.00619 | −0.0022 | 0.044271 | 0.063439 | −0.02052 | 0.068679 | 0.018235 | −0.01735 | 0.064731 |
| 6 | −0.00733 | −0.03609 | −0.0119 | −0.00472 | 0.03363 | 0.059251 | −0.02184 | 0.062176 | 0.00745 | 0.12474 | 0.053252 |
| 7 | −0.02651 | −0.04621 | −0.0344 | −0.02546 | 0.018434 | 0.026167 | −0.03839 | 0.036112 | −0.00805 | −0.03462 | 0.026261 |
| 8 | −0.0011 | −0.02572 | −0.00372 | 0.00089 | 0.033654 | 0.053897 | −0.01267 | 0.052586 | 0.014541 | −0.01445 | 0.044302 |
| 9 | −0.01018 | −0.01856 | −0.0111 | −0.01119 | 0.002095 | 0.011866 | −0.0171 | 0.015242 | −0.00679 | −0.01472 | 0.000904 |
| 10 | 0.012684 | −0.0091 | 0.006927 | 0.01417 | 0.032106 | 0.057286 | −0.00056 | 0.056165 | 0.011502 | 0.000243 | 0.039765 |
| 11 | 0.003491 | −0.00371 | −0.00091 | −0.00527 | −0.0028 | 0.032738 | 0.008198 | 0.006448 | 0.000225 | −0.00985 | −0.00025 |
| 12 | −0.00193 | −0.00516 | −0.00549 | −0.00161 | 0.001703 | 0.004023 | −0.00305 | 0.002902 | 0.00052 | −0.00376 | −0.00207 |
| 13 | 0.003027 | −0.00565 | 0.001362 | −0.00212 | 0.001808 | 0.026834 | 0.003483 | 0.020654 | 0.00406 | −0.00671 | 0.002637 |
| 14 | −0.01381 | −0.03485 | −0.01317 | −0.01554 | 0.031652 | 0.047767 | −0.02368 | 0.055314 | 0.014061 | −0.0194 | 0.039767 |
| 15 | −0.03087 | −0.06311 | −0.02451 | −0.03182 | 0.056674 | 0.072839 | −0.04485 | 0.081539 | 0.020825 | −0.03925 | 0.079322 |
| 16 | −0.0033 | −0.02218 | −0.00627 | 0.001097 | 0.022468 | 0.043236 | −0.01359 | 0.045187 | 0.002474 | −0.01572 | 0.030326 |
| 17 | −0.00218 | −0.02229 | −0.00732 | −0.00077 | 0.022616 | 0.044979 | −0.0139 | 0.046594 | 0.000772 | −0.01558 | 0.029245 |
| 18 | 0.00729 | −0.01522 | 0.002257 | 0.009412 | 0.033241 | 0.055264 | −0.00531 | 0.056575 | 0.012446 | −0.01133 | 0.036738 |
| 19 | −0.01581 | −0.03255 | −0.01634 | −0.01755 | −0.00404 | 0.03841 | −0.01874 | 0.021155 | −0.01088 | −0.03638 | 0.000566 |
| 20 | −0.00289 | N/A | −0.006 | −0.00485 | 0.009995 | 0.036369 | −0.01073 | 0.019224 | −0.00105 | −0.01969 | 0.024824 |
| 21 | −0.03344 | −0.02433 | −0.00451 | −0.00181 | 0.02547 | 0.04652 | −0.01574 | 0.046689 | 0.006945 | −0.0138 | 0.040655 |
| 22 | −0.00727 | −0.03004 | −0.00871 | −0.00087 | 0.028813 | 0.041259 | −0.02134 | 0.052184 | 0.008329 | −0.01294 | 0.041695 |
| 23 | −0.00531 | −0.02333 | −0.00893 | −0.00701 | 0.019872 | 0.045158 | −0.01685 | 0.043869 | 0.00741 | −0.01662 | 0.034656 |
| 24 | −0.00995 | −0.03366 | −0.01235 | −0.01084 | 0.034442 | 0.045149 | −0.0236 | 0.052214 | 0.017585 | −0.01861 | 0.047131 |
| 25 | 0.000862 | −0.00784 | −0.0034 | −0.0008 | 0.004996 | 0.019998 | −0.00354 | 0.015264 | 0.001343 | −0.00623 | 0.006933 |
| 26 | 0.003647 | −0.0136 | 0.004612 | 0.095502 | 0.029063 | 0.048544 | −0.00613 | 0.048576 | 0.010086 | −0.00664 | 0.035508 |
| 27 | −0.00199 | −0.03167 | −0.00475 | −0.00041 | 0.015012 | 0.026807 | −0.00467 | 0.020617 | 0.009086 | −0.00731 | 0.016484 |
| Median | −0.00344 | −0.02502 | −0.00629 | −0.00263 | 0.02547 | 0.045149 | −0.01574 | 0.046689 | 0.00745 | −0.01472 | 0.035508 |
| Average | −0.00513 | −0.02315 | −0.0079 | −0.00488 | 0.022572 | 0.042456 | −0.01462 | 0.042004 | 0.006329 | −0.00449 | 0.031586 |

The complete data set was examined, and nine (9) chromosomes whose median log ratios were the most skewed from zero were chosen as “anchor chromosomes” in this example. These 9 anchor chromosomes were chromosomes 3, 4, 5, 6, 13, 16, 17, 19, and 22. Table 5 summarizes the approximate GC corrected median log ratio values for the 9 anchor chromosomes. This set of anchor chromosomes was then used to anchor the chromosomal adjustment values.

TABLE 5
Approximate GC wave-corrected log ratio values for chosen anchor chromosomes

| | Chr 3 | Chr 4 | Chr 5 | Chr 6 | Chr 13 | Chr 16 | Chr 17 | Chr 19 | Chr 22 |
|---|---|---|---|---|---|---|---|---|---|
| Sample 1 | −0.0093 | −0.0157 | −0.00949 | −0.00553 | −0.00745 | −0.0005 | 0.008992 | −0.00173 | −0.00496 |
| Sample 2 | −0.03315 | −0.04359 | −0.03631 | −0.0333 | −0.03086 | 0.0317 | 0.054332 | 0.062506 | 0.043765 |
| Sample 3 | −0.04415 | −0.05731 | −0.04593 | −0.05084 | −0.0448 | 0.046651 | 0.070621 | 0.080401 | 0.065346 |
| Sample 4 | −0.0337 | −0.05271 | −0.04378 | −0.03523 | −0.03261 | 0.0364! | 0.064573 | 0.066972 | 0.055294 |
| Sample 5 | −0.0321 | −0.04615 | −0.05667 | −0.03717 | −0.03334 | 0.044271 | 0.063439 | 0.068679 | 0.064731 |
| Sample 6 | −0.03626 | −0.05056 | −0.04182 | −0.03774 | −0.03609 | 0.03363 | 0.059251 | 0.062176 | 0.053252 |
| Sample 7 | −0.04633 | −0.052 | −0.04464 | −0.05055 | −0.04621 | 0.018434 | 0.026167 | 0.036112 | 0.026261 |
| Sample 8 | −0.02689 | −0.04536 | −0.04851 | −0.02909 | −0.02572 | 0.033654 | 0.053897 | 0.052586 | 0.044302 |
| Sample 9 | −0.01797 | −0.02041 | −0.01803 | −0.01648 | −0.01856 | 0.002095 | 0.011866 | 0.015242 | 0.000904 |
| Sample 10 | −0.00798 | −0.01632 | −0.01276 | −0.00707 | −0.0091 | 0.032106 | 0.057286 | 0.056165 | 0.039765 |
| Sample 11 | −0.00213 | −0.02353 | −0.01831 | 0.002174 | −0.00371 | −0.0028 | 0.032738 | 0.006448 | −0.00025 |
| Sample 12 | −0.00585 | −0.00924 | −0.00646 | −0.00326 | −0.00516 | 0.001703 | 0.004023 | 0.002902 | −0.00207 |
| Sample 13 | −0.00574 | −0.02223 | −0.0152 | −0.00149 | −0.00565 | 0.001808 | 0.026834 | 0.020654 | 0.002637 |
| Sample 14 | −0.03508 | −0.05037 | −0.0374 | −0.03666 | −0.03485 | 0.031652 | 0.047767 | 0.055314 | 0.039767 |
| Sample 15 | −0.06277 | −0.08654 | −0.06486 | −0.06827 | −0.06311 | 0.056674 | 0.071839 | 0.081539 | 0.079322 |
| Sample 16 | −0.02166 | −0.02783 | −0.02431 | −0.02163 | −0.02218 | 0.022468 | 0.043236 | 0.045187 | 0.030326 |
| Sample 17 | −0.02237 | −0.03138 | −0.02595 | −0.02218 | −0.02229 | 0.022616 | 0.044979 | 0.046594 | 0.029245 |
| Sample 18 | −0.01482 | −0.0245 | −0.01794 | −0.01339 | −0.01522 | 0.033241 | 0.055264 | 0.056575 | 0.036738 |
| Sample 19 | −0.03116 | −0.05438 | −0.04546 | −0.02614 | −0.03255 | −0.00404 | 0.03841 | 0.021155 | 0.000566 |
| Sample 20 | −0.02341 | −0.03475 | −0.02741 | −0.01826 | N/A* | 0.009995 | 0.036369 | 0.019224 | 0.024824 |
| Sample 21 | −0.02621 | −0.03508 | −0.0274 | −0.02621 | −0.02433 | 0.02547 | 0.04652 | 0.046689 | 0.040655 |
| Sample 22 | −0.02693 | −0.0287 | −0.02671 | −0.03189 | −0.03004 | 0.028813 | 0.041259 | 0.052184 | 0.041695 |
| Sample 23 | −0.02592 | −0.03854 | −0.02957 | −0.02499 | −0.02333 | 0.019872 | 0.045158 | 0.043869 | 0.034656 |
| Sample 24 | −0.03331 | −0.04763 | −0.0375 | −0.03521 | −0.03366 | 0.034442 | 0.045149 | 0.052214 | 0.047131 |
| Sample 25 | −0.00673 | −0.01192 | −0.01107 | −0.00725 | −0.00784 | 0.004996 | 0.019998 | 0.015264 | 0.006933 |
| Sample 26 | −0.01377 | −0.02265 | −0.01609 | −0.01214 | −0.0136 | 0.029063 | 0.043544 | 0.048576 | 0.035508 |
| Sample 27 | −0.01247 | −0.02671 | −0.01704 | −0.01182 | −0.03167 | 0.015012 | 0.026807 | 0.020617 | 0.016484 |

*Sample 20 had a large aberration in chromosome 13; thus no value is reported in that case, and sample 20 was excluded for calculations for chromosome 13.
*Sample 20 had a large aberration in chromosome 13; thus no value is reported in that case, and sample 20 was excluded for calculations for chromosome 13.

### Example 3

### Determination of Anchor Values

To derive chromosomal adjustment values, anchor values were first calculated for the anchor chromosomes chosen in Example 2. As described above, the anchor value a₁ for a particular anchor chromosome j was determined by comparing the median log ratios of anchor chromosome j to the median log ratios of the “most skewed” anchor chromosome, i.e., the anchor chromosome whose median log ratio was most skewed from 0. In this example, chromosome 19 was identified as the “most skewed” anchor chromosome. Median log ratio values (after correction) for a given anchor chromosome (e.g., chromosome 3) were then plotted against the median log ratio values of chromosome 19 for the 27 samples. The anchor value for the given chromosome (e.g., chromosome 3) was then defined as the slope of the trend line (calculated using robust regression) from the datasets. This process was repeated for all other anchor chromosomes to obtain the set of anchor values. The anchor value for chromosome 19 was 1. Calculated anchor values are shown in Table 6 below.

TABLE 6
Anchor values of anchor chromosomes

| Chromosome | Calculated anchor value |
|---|---|
| 16 | 0.5684 |
| 17 | 0.9361 |
| 19 | 1.0000 |
| 22 | 0.7911 |
| 3 | −0.5314 |
| 4 | −0.7660 |
| 5 | −0.6520 |
| 6 | −0.5649 |
| 13 | −0.5185 |

### Example 4

### GC Wave Correction Improves the Sensitivity of Aberration Calling

This example demonstrated that GC wave correction reduces the wave effect and improves the specificity and sensitivity of aberration calling in aCGH.

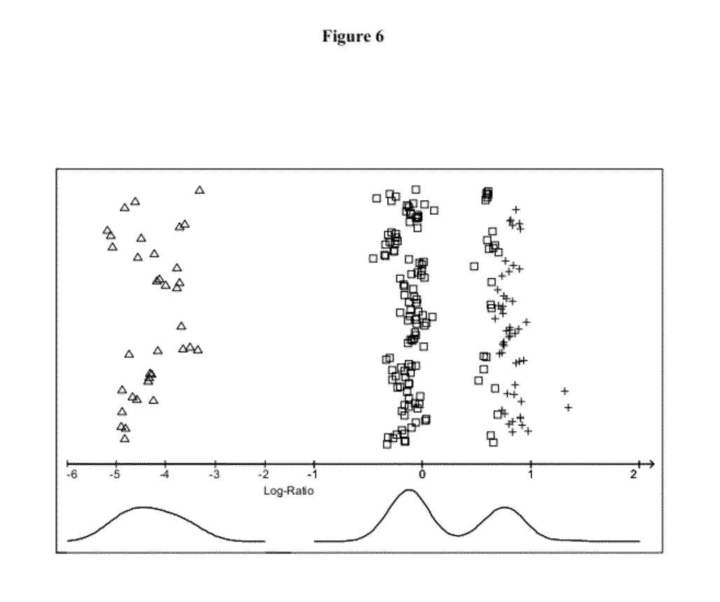

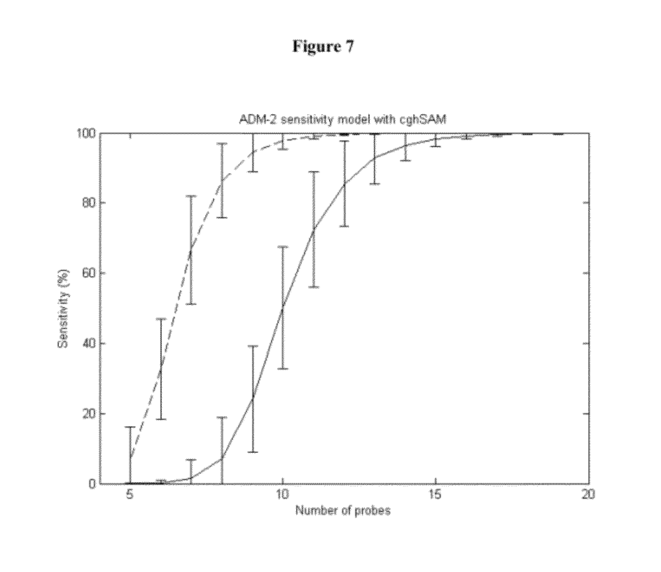

Two hundred eighteen arrays were analyzed in silico both before and after GC-wave correction. For example, wave effects of a region of chromosome 19 were shown in FIG. 5. The two-part correction described herein reduced the wave effects (FIG. 5B) which improved the sensitivity of the platform under a re-optimized ADM2 cut-off. In addition, DNA analytics were used to calculate aberrant regions before GC correction using a pre-defined optimized ADM2 cut-off. After correction, the data set was analyzed with a re-optimized ADM2 cut-off (FIG. 6). Sixty-one aberrations in GSTT1 (a common copy number variation (CNV) region on chromosome 22) were detected before correction. After correction, 25 additional amplifications were called. No aberration was detected in the remaining 132 arrays. Thus, the present GC wave correction resulted in 23% increase in sensitivity for a common CNV region containing the GSTT1 gene. Since the most common ploidy of GSTT1 is 1, amplifications of this region serve as a model for heterozygous deletions in diploid regions of the genome. The introduction of GC slope as a QC metric helped remove samples that were prone to false positive aberration calls in the assay. Specificity improved by 5.5% with only a 1.4% increase in the number of QC failures. Exemplary results before and after GC wave correction are summarized in Table 7 below.

TABLE 7
Exemplary results of GC Correction on 218 arrays

| | Before | After | Result |
|---|---|---|---|
| QC Failures | 7 | 10 | +3 |
| Repeat Rate | 3.2% | 4.6% | +1.4% |
| False Positives | 16 | 4 | −12 |
| False Positive % | 7.3% | 1.8% | −5.5% |
| GSTT1 Calls | 61 | 86 | +25 |
| GSTT1 Sensitivity | 56% | 79% | +23% |

In addition to GSTT1, 21 other new calls were generated after correction. The increase in QC failures was due to the introduction of GC slope as a QC metric. 3 samples that had false positives would fail the QC check with the new criteria.

In conclusion, this example has shown that the methods of the invention using GC wave correction reduce the GC wave effect, and therefore, improve the specificity and sensitivity of aberration calling in aCGH. The introduction of GC wave slope provides a pathway for removing problematic samples from the assay. The decrease in the false positive rate in combination with an increase in sensitivity allows for more accurate detection of small CNVs throughout the genome.

### Other Embodiments

Other embodiments of the invention will be apparent to those skilled in the art from a consideration of the specification or practice of the invention disclosed herein. It is intended that the specification and examples be considered as exemplary only, with the true scope of the invention being indicated by the following claims.

### INCORPORATION OF REFERENCES

All publications and patent documents cited in this application are incorporated by reference in their entirety to the same extent as if the contents of each individual publication or patent document were incorporated herein.

What is claimed is:

1. A method of comparative genomic hybridization (CGH) data analysis comprising:
(a) determining log ratio values for a plurality of probes hybridized to a genome of a test sample and a genome of a reference sample, wherein the reference sample has a known ploidy, wherein each individual probe has a known chromosome location and a pre-determined GC content;
(b) determining a log ratio base line for each chromosome based on the GC content of the chromosome; and
(c) normalizing the log ratio value for each individual probe against the log ratio baseline of the corresponding chromosome from which the individual probe is derived.

2. The method of claim 1, wherein the plurality of probes are located on an array.

3. The method of claim 1, wherein the step of determining the log ratio base line comprises a step of determining GC slope for each chromosome by comparing log ratios of probes derived from each chromosome to their respective percent GC.

4. The method of claim 1, wherein the step of normalizing the log ratio value for each individual probe i comprises adjusting the log ratio value for each probe i by a correction factor defined by the following formula:
CorrectionFactorᵢ=LRBaseline−m×PercentGCᵢ−b (Eq. 1)
where m is the GC content slope of the probe's chromosome and b is the y-intercept.

5. The method of claim 1, further comprising determining median log ratios for individual chromosomes based on the normalized log ratio value for individual probes.

6. The method of claim 1, further comprising assessing GC slope of the array, wherein if the GC slope of the array exceeds a predetermined threshold, the test sample is failed.

7. The method of claim 1, further comprising correcting a subset of chromosomes' log ratios by their respective chromosomal adjustment factors indicative of assay-based deviation from baseline for a normal diploid region.

8. The method of claim 7, wherein the subset of chromosomes are selected from anchor chromosomes pre-determined to have skewed median log ratios that deviate from baseline in normal diploid regions.

9. The method of claim 8, wherein the anchor chromosomes are pre-determined based on archived log ratio values obtained under the same assay conditions and have normalized median log ratios furthest from baseline.

10. The method of claim 9, wherein the anchor chromosomes comprise at least one of chromosomes 3, 4, 5, 6, 13, 16, 17, 19, 22, or a combination thereof.

11. The method of claim 8, wherein each individual anchor chromosome j has an anchor value aⱼ defined by the slope of a trend line defined by plotting the archived median log ratios of chromosome j against the archived median log ratios of the anchor chromosome that was most skewed from baseline.

12. The method of claim 7, wherein the chromosomal adjustment factors are calculated from a subset of anchor chromosomes by excluding a plurality of outlier chromosomes whose median log ratios skew the furthest among the anchor chromosomes.

13. The method of claim 12, wherein 40% of the anchor chromosomes are designated as outlier chromosomes.

14. The method of claim 13, wherein the outlier chromosomes are excluded by a least-squares fit analysis according to Equation 2:
$$min {\sum }_{j = 1}^{x} {( {a}_{j} - e \cdot {m}_{j} )}^{2} \qquad ( Eq . 2 )$$
wherein aⱼ is the anchor value for individual anchor chromosome j, mⱼ is the normalized median log ratio value for individual anchor chromosome j.

15. The method of claim 14, wherein the least fit analysis comprises:
(i) calculating the summation of Eq. 2 for the set of x anchor chromosomes, each time omitting one chromosome in the set, such that each anchor chromosome in the set is omitted once during calculation, wherein a chromosome is identified as an outlier if its omission results in the smallest summation;
(ii) removing the outlier chromosome identified at step (i) from the set;
(iii) recursively searching the remaining x−1 anchor chromosomes for the next outlier using step (i);
(iv) repeating steps (i) to (iii) until 40% of the anchor chromosomes are excluded as outliers.

16. The method of claim 8, wherein the chromosomal adjustment factors for the set of anchor chromosomes are determined by:
(a) finding a coefficient e* such that the difference between the anchor values a and e*m is minimized according to Equation 2
$$min {\sum }_{j = 1}^{x} {( {a}_{j} - e \cdot {m}_{j} )}^{2} \qquad ( Eq . 2 )$$
wherein aⱼ is the anchor value for individual anchor chromosome j, mⱼ is the normalized median log ratio value for anchor chromosome j; and
(b) determining chromosomal adjustment factor for anchor chromosome j as aⱼ/e*.

17. The method of claim 16, wherein the set of anchor chromosomes' log ratios are corrected by subtracting the log ratios for individual probes derived from anchor chromosome j with corresponding chromosomal adjustment factor aⱼ/e*.

18. The method of claim 16, wherein the method further comprises first comparing the summation of Equation 2 for non-outlier chromosomes to a pre-determined threshold and wherein, if the summation exceeds the pre-determined threshold, the sample does not undergo chromosomal adjustment.

19. The method claim 1, further comprising providing an output file comprising corrected log ratio values for individual probes for aberration detection.

20. The method of claim 19, wherein the aberration detection comprises determining if the test sample contains an abnormal copy number of a chromosome based on the corrected log ratio values.

21. The method of claim 20, further comprising detecting a disease, disorder, or condition associated with the abnormal copy number of the chromosome, or a carrier thereof.

22. The method of claim 1, wherein the test sample is obtained from cells, tissue, whole blood, plasma, serum, urine, stool, saliva, cord blood, chorionic villus sample, chorionic villus sample culture, amniotic fluid, amniotic fluid culture, or transcervical lavage fluid.

23. The method of claim 22, wherein the test sample is a prenatal sample.

24. A system for comparative genomic hybridization (CGH) data analysis, comprising:
a) means to receive log ratio values for a plurality of probes hybridized to a genome of a test sample and a genome of a reference sample, wherein the reference sample has a known ploidy, wherein each individual probe has a known chromosome location and a pre-determined GC content;
b) a storage device configured to store data comprising (i) the chromosome location and pre-determined GC content for each individual probe, (ii) GC content for each chromosome, and (iii) anchor values for pre-determined anchor chromosomes indicative of assay-dependent deviation;
c) a determination module configured to determine a log ratio base line for each chromosome based on the GC content of the chromosome;
d) a computing module adapted to (i) normalize the log ratio value for each individual probe against the log ratio baseline of the corresponding chromosome from which the individual probe is derived; (ii) calculate median log ratios for individual chromosomes based on the normalized log ratio value for individual probes, (iii) select a subset of anchor chromosomes by excluding outlier chromosomes whose median log ratios skew the furthest among the anchor chromosomes based on the anchor values and the normalized median log ratios for each anchor chromosome; (iv) calculate chromosomal adjustment factors indicative of assay-based deviation from baseline based on the subset of anchor chromosomes selected at step (iii) and normalize the anchor chromosomes' log ratio values against their respective chromosomal adjustment factors; (v) determine the quality of GC slope and/or the chromosomal adjustment factors to determine if the correction should be made; and
e) a second storage device configured to store an output file comprising corrected log ratio values for individual probes for aberration detection.

25. The system of claim 24, further comprising a means to carry out aberration detection.

26. A computer readable medium having anchor values recorded thereon for anchor chromosomes pre-determined to have skewed median log ratios that deviate from baseline in normal diploid regions in a pre-determined aCGH assay, wherein the anchor value aⱼ for each individual anchor chromosome j is defined by a slope of a trend line defined by plotting archived median log ratios obtained using the pre-determined aCGH assay of chromosome j against archived median log ratios of the anchor chromosome that was most skewed from baseline.

27. A kit for comparative genomic hybridization (CGH) analysis, comprising:
(a) a plurality of probes for aCGH analysis, wherein each individual probe has a known chromosome location and a pre-determined GC content; and
(b) a computer-readable medium according to claim 25.

28. The kit of claim 26, further comprising one or more reagents for conducting the pre-determined CGH assay.
